(19) United States
(12) Patent Application Publication
(10) Pub. No.: US 2020/0193381 A1
(43) Pub. Date: Jun. 18, 2020

(54) Interactive Systems and Methods for Recruiting Candidates

(71) Applicants: Chad Steven Lawrence, Melissa, TX (US); Anthony Omondi Olendo, Port of Spain (TT)

(72) Inventors: Chad Steven Lawrence, Melissa, TX (US); Anthony Omondi Olendo, Port of Spain (TT)

(21) Appl. No.: 16/221,502

(22) Filed: Dec. 15, 2018

(51) Int. Cl. G06Q 10/10; G06Q 10/06; G06Q 20/08

(52) U.S. Cl. CPC G06Q 10/1053; G06Q 20/085; G06Q 10/063112

(57) ABSTRACT

An interactive system for recruiting candidates, including at least one processor; a memory connected to the at least one processor; a module that when loaded into the at least one processor causes the at least one processor to accept the candidates' biographical data, skillset data, and educational data; display lists of industry skills and industry sub-skills; accept job postings by hiring authorities, the job postings having biographical data, required industry skills, and required industry sub-skills; accept selections of the industry skills and industry sub-skills by hiring authorities relative to the job postings and candidates relative to their skillset data and educational data; match the selected industry skills and sub-industry skills of the hiring authorities and candidates; notify the hiring authorities and candidates of the match, wherein the candidates' biographical data is not sent to the hiring authorities in the notification; and facilitate an interaction between matched candidates and hiring authorities.

### TECHNICAL FIELD OF THE INVENTION

This invention relates, in general, to candidate recruiting, and in particular, to interactive systems and methods for recruiting candidates.

### BACKGROUND OF THE INVENTION

Without limiting the scope of the present invention, its background will be described in relation to interactive systems and methods for recruiting candidates, as an example.

Since World War II, companies (company and/or hiring authorities) looking to place job positions and fill them with qualified candidates has been a lengthy process. There was a shortage of men after World War II, so companies popped up to fill the vacant positions. These companies request and post detailed and lengthy job descriptions in the popular media of the day, such as newspapers, and the like, requesting resumes of candidates.

Candidates then send their lengthy resumes to the hiring authority, which gives little review if any at all due to the volume of submitted resumes. If the hiring authority actually does stumble onto a resume that indicates the candidate may be qualified for the position, then additional written communications are transmitted by the parties leading to an interview performed via telephone or in person.

One problem with the above process is that job descriptions sent by the hiring authority may utilize words and/or terms that are important to them, such as looking for “Vice President of marketing of our company,” but the candidate is looking of a vice president position in a marketing company. An example, if a recruiter is looking for a Vice President of Business Development role, the searches may show Vice President of Marketing, etc. and not what they are looking for.

There also exist businesses to help candidates write their resumes. Resumes do not quantify a candidates' ability to do a particular job, but that they quantify the ability to write down what the candidates want to convey about their education, skillsets, etc. Also known are trainings for crafting a candidates' resume to match keywords used in job postings. These activities just make the entire recruiting process even longer.

Recruiters and hiring authorities spend very little time reviewing these resumes due to the sheer volume of them that are received. So, candidates spend a lot of time preparing a resume that will ultimately be given a few seconds being reviewed.

Computers and their subsequent networked connections have made it slightly easier to get job position information out to potential candidates, but the underlying process basically remains the same. This also applies to today's electronic recruiting systems that are all web-based systems. Essentially, the above process of lengthy job position descriptions are posted on the Internet with hopes of a candidate spending vast amounts of time online reading the endless, verbose postings and their requirements. Lengthy resumes are submitted to the hiring authority, which ultimately aren't looked at.

Another problem with current recruiting practices is that recruiters and the companies they work for require recruiting fees for their services for facilitating the finding of one or more candidate(s). These recruiting fees, which are paid by the hiring authority can be substantial, such as a few percent of the candidate's compensation, for example. In some examples, the recruiter's fee for filling or completing a position may be equal to 20%-25% of the candidate's compensation.

Lack of trust is also another problem with today's recruiting activities. Candidates may embellish their skillsets, background, past responsibilities, educational achievements, and the like causing a slight order of mistrust of the candidates handled by recruiters. Through the sheer volume of candidates handled by recruiters, they have to deal with these inaccuracies that causes mistrust between candidates and recruiters. This causes a high failure rate of candidates not being acceptable to the hiring authorities and thus creates more work for the recruiters causing higher recruiting fees to the hiring authorities. Thus, hiring authorities are not only paying for the sole candidate that they ultimately hire, but for all of the failed candidates screened or run through the hiring operation due to the high failure rate.

Further, hiring authorities may contract with one or more contingent recruiters, thus they compete against each other. This creates a “horse race” between the recruiters. This causes the recruiters to send as many close matching resumes as possible to the hiring authority in hopes of them hiring one of the candidates before the other recruiters can supply the quality candidate. Also, by sending an avalanche of resumes first, the hiring authority is bogged down reviewing them and isn't able to review a competing recruiter's sent resumes. This existing method of recruiting creates the poor relationship between the hiring authorities and the recruiters.

Candidates working for their current employers can't search web-based candidate boards and the like without their employer noticing such use of the company equipment.

Another problem is that hiring authorities can not determine quickly the geographical area of available candidates. Additionally, oftentimes candidates can not determine the geographical area of available positions and/or hiring authorities. Further, the clunkiness of today's practices lend themselves to long periods of time where candidates are not updated on the status of their search and/or resume submission. This is because resumes may sit on a desk of hiring authorities for weeks or months and by the time they process is restarted, a particular candidate may have already found another position. The lack of communication from the hiring authority to the candidates may convince the candidates that the hiring authority is not interested in them anymore.

Yet another problem with today's recruiting practices is that discrimination is prevalent. Because today's electronic systems display all of a candidates biographical information, such as age, gender, race, name and the like it provides a hiring authority with the ability to quickly screen those candidates based on these discriminatory data. For example, candidates with typical American names, such as “Joe,” may get an interview, but a candidate with non-typical American name, such as “Jose,” may not.

Still yet another problem is that companies spend large amounts of time writing a perfect job description that ultimately is not read by candidates. These descriptions can be written ad nauseum and verbose so that today's candidates with shorter attention spans simply do not read them thoroughly.

Also, current electronic practices requires either party to switch platforms, such as the parties may start out with a phone call, and then the candidate has to go home to access their resume to be sent over a computer later. And if the email address is incorrect, then the resume may not be received causing more delays in moving the parties closer together.

### SUMMARY OF THE INVENTION

The present invention relates to interactive systems and methods for recruiting candidates. In one embodiment, the present invention disclosed herein is directed an interactive system for recruiting candidates, including at least one processor; a memory connected to the at least one processor; a module that when loaded into the at least one processor causes the at least one processor to accept the candidates' biographical data, skillset data, and educational data; display lists of industry skills and industry sub-skills; accept job postings by hiring authorities, the job postings having biographical data, required industry skills, and required industry sub-skills; accept selections of the required industry skills and required industry sub-skills by hiring authorities relative to the job postings and candidates relative to their skillset data and educational data; match the selected industry skills and sub-industry skills of the hiring authorities and candidates; notify the hiring authorities and candidates of the match, wherein the candidates' biographical data is not sent to the hiring authorities in the notification; and facilitate an interaction between matched candidates and hiring authorities.

In one aspect, the module may cause the at least one processor to display a geographical map to the hiring authorities having indicia of matched candidates within a defined geographical area; and upon selecting a matched candidate, display the selected matched candidate's one or more biographical data, skillset data, and educational data to the hiring authorities. In addition, the module causes the at least one processor to display a geographical map to the candidates having indicia of matched hiring authorities within a defined geographical area; and upon selecting a matched hiring authority, display the selected matched hiring authority's biographical data, industry skills, and industry sub-skills to the candidates.

In another aspect, the module may cause the at least one processor to record a video of candidates to be viewed by hiring authorities once the candidates and hiring authorities are matched. In yet another aspect, the module may cause the at least one processor to display candidates' biographical data once the candidates and hiring authorities are matched.

Also, the module may cause the at least one processor to accept payments from hiring authorities for posting jobs. Further, the module may cause the at least one processor to display candidates biographical data once the candidates and hiring authorities are matched. Further, the module may cause the at least one processor to display to the hiring authorities a list of matched candidates and one or more selectable buttons for view biographical data and book interaction. In yet another aspect, the module may cause the at least one processor to display to the hiring authorities a list of matched candidates and one or more selectable buttons for hire and reject.

Additionally, when the book interaction is selected the module may cause the at least one processor to display to the hiring authorities one or more of a date field, interaction type field, a message field, and a book button. Also, when the book interaction is selected the module may cause the at least one processor to display to the hiring authorities one or more of a an interaction field, a hire button, and a final shortlist button.

In another embodiment, the present invention is directed to an interactive method for recruiting candidates, including storing data from one or more candidates; storing data from one or more hiring authorities; accepting at least one job posting from the one or more hiring authorities, the at least one job posting having standard industry skills and standard industry sub-skills; matching the at least one of the one or more candidates' data with the job posting standard industry skills and standard industry sub-skills; notifying the matched one or more candidates and one or more hiring authorities that a match was made; and facilitating an interaction between the matched one or more candidates and one or more hiring authorities.

In one aspect, the accepting at least one job posting further includes accepting payment from the one or more hiring authorities for posting the at least one job posting. In another aspect, the storing data from one or more candidates further includes storing a video of the one or more candidates for viewing by the one or more hiring authorities. In yet another aspect, the matching further includes providing a choice to the one or more candidates to accept or reject the at least one job posting, wherein the one or more candidates accepts the at least one job posting; and providing a choice to the one or more hiring authorities to accept or reject the accepted candidate.

In yet another aspect, the matching further includes providing a choice to the one or more candidates to accept or reject the at least one job posting, wherein the one or more candidates accepts the at least one job posting; and providing a choice to the one or more hiring authorities to accept or reject the accepted candidate.

In still yet another aspect, the matching further includes displaying a geographical map to the hiring authorities having indicia of matched candidates within a defined geographical area; and upon selecting a matched candidate, displaying the selected matched candidate's one or more biographical data, skillset data, and educational data. Further, the matching further includes displaying a geographical map to the candidates having indicia of matched hiring authorities within a defined geographical area; and upon selecting a hiring authority, displaying the selected matched hiring authorities one or more biographical data, industry skills, and industry sub-skills to the candidates.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is an illustration of a system for recruiting candidates according to an embodiment;

FIG. 2 is block diagram of a system for recruiting candidates of FIG. 1 according to an embodiment;

FIG. 3 is a network diagram of a client-server system in which various example embodiments may be operated according to an embodiment;

FIG. 4 is a block diagram of a mobile device/computing device according to an embodiment;

FIGS. 5A-5H are graphical user interface (GUI) screen shots of a display of a mobile device/computing device according to an embodiment;

FIGS. 6A-6L are GUI screen shots of a display of a mobile device/computing device according to an embodiment;

FIGS. 7A-7C are GUI screen shots of a display of a mobile device/computing device according to an embodiment;

FIGS. 8A-8B are GUI screen shots of a display of a mobile device/computing device according to an embodiment;

FIGS. 9A-9C are GUI screen shots of a display of a mobile device/computing device according to an embodiment; and

FIGS. 10-25 are flowcharts of methods for recruiting candidates according to an embodiment.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not limit the scope of the present invention.

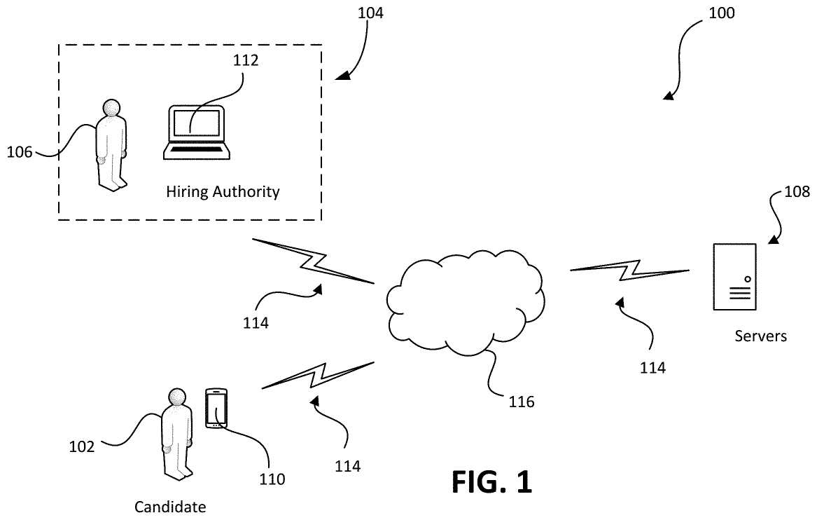

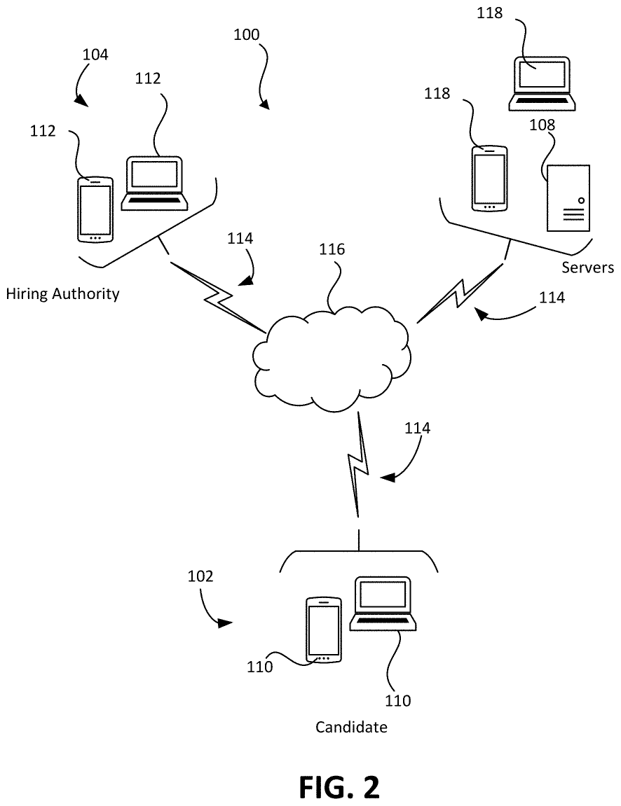

Described herein are embodiments for interactive systems and methods for recruiting candidates (hereinafter referred to as “recruiting system”). Referring initially to FIGS. 1 and 2, an embodiment of a recruiting system is illustrated and generally designated 100. Recruiting system 100 may include one or more candidate(s) and/or user(s) 102 (hereinafter “candidate 102”) who may be interested in finding employment and/or contractual positions with a hiring authority as described herein. Additionally, recruiting system 100 may include one or more companies, businesses, hiring entities, hiring authorities, employers, and the like (hereinafter “hiring authority 104”) who may be interested in posting/filling employment and/or contractual positions to be filled by one or more candidate(s) 102. Additionally, hiring authority 104 may include one or more users 106 for assisting hiring authority 104 in using recruiting system 100 in posting and filling such positions. As described herein, candidate 102 and hiring authority 104 may be one or more candidates and hiring authorities. Any number of candidates 102 and hiring authorities 104 may utilize recruiting system 100.

Recruiting system 100 may also include one or more servers 108 that are used by candidate 102 and hiring authority 104 via terminals or computing devices 110, 112, respectively. Computing devices 108, 110 may be wired devices and/or wireless devices as would be understood by those skilled in the art. For example, computing devices 108, 110 may be mobile phones, smart phones, electronic tablets, desktop computers, laptop computers, smart watches, wireless mobile devices, and the like.

Recruiting system 100 may further include a network 116 for providing wired and/or wireless communications between computing devices 108, 110, candidate 102, hiring authority 104, and/or servers 108 via communication links 114. In one non-limiting example, computing device 110 may be a mobile phone or other wireless mobile device that is conveniently operated by candidate 102. Likewise, in another non-limiting example, computing device 112 may be a personal computer and/or laptop utilized by hiring authority 104 and/or users 106.

In one embodiment, via one or more wired or wireless communication links 114, recruiting system 100 may communicate via with other communication links to facilitate communication between computing devices 110, 112 and servers 108. All of these devices may communicate to each other via any of the communications links described herein. Although FIGS. 1 and 2 shows a few specific arrangements of the communication links and devices, recruiting system 100 may include any combination and arrangement of such communication links. Network 116 may be any type of communications networks, such as Internet, world wide web (“WWW”), intranets, wireless local area networks (“WLANs”), local area networks (“LANs”), metropolitan area networks (“MAN”), virtual private networks (“VPNs”), plain old telephone network (“POTS”) and the like. Additionally, network 116 may be any network that is capable of exchanging data and information between computing devices 110, 112 and servers 108.

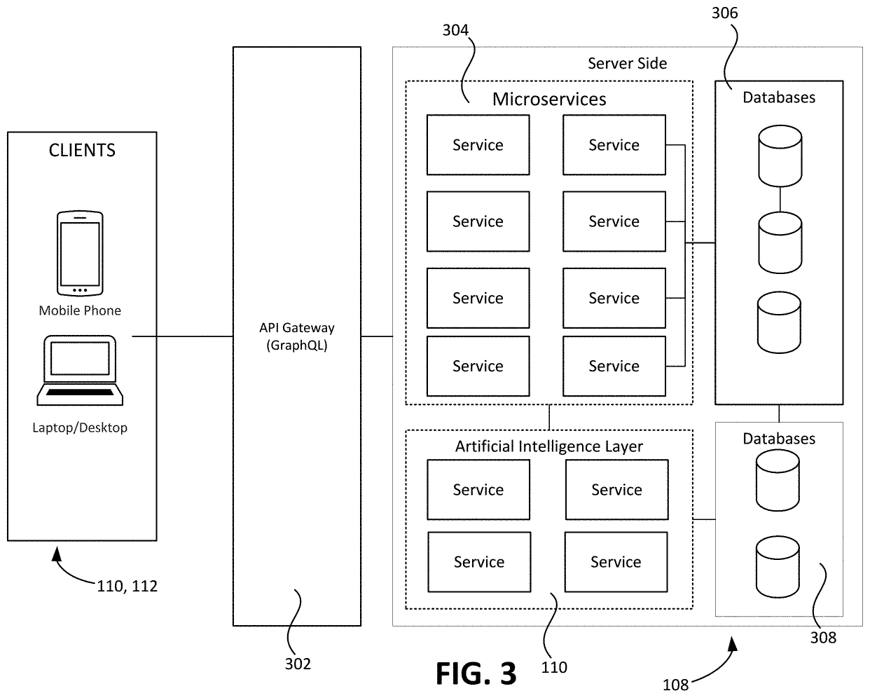

Additionally, recruiting system 100 may include additional computing devices 118 that may be in communication with servers 108 for programming, communicating, etc. with servers 108 as would be known to those skilled in the art. Turning now to FIG. 3, recruiting system 100 may also include an application programming interface (“API”) 302 that are a set of protocols, functions, routines, commands, etc. for developing software are further described herein. API 302 may also may also facilitate communications between computing devices 110, 112 and servers 108.

In addition, servers 108 may include one or more microservices 304 for providing the functionality and features of recruiting system 100 to candidate 102 and/or hiring authority 104. Additionally, servers 108 may include artificial intelligence functionality to perform matching capabilities as further described herein. Servers 108 may also include one or more databases 306 and/or 308 for storing data associated with recruiting system 100 as would be known to those skilled in the art.

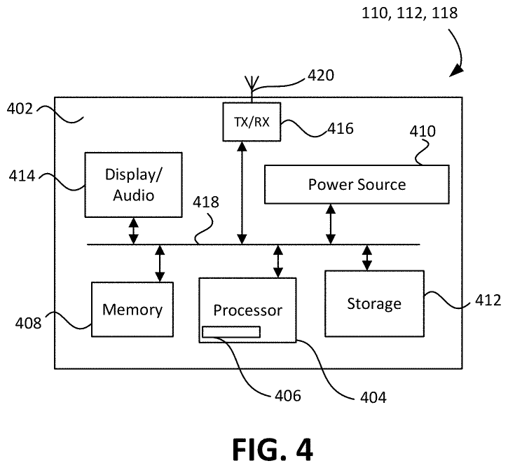

Referring now to FIG. 4, computing devices 110, 112 and/or computing devices 118 may include a printed circuit board (“PCB”) 402 that has a digital processor 404 for processing electrical signals produced by any of the components and software of computing devices 110, 112 and/or computing devices 118. Digital processor 404 may further run software 406 for executing the processes, methods, and the like for users of recruiting system 100. Software 406 contains necessary algorithms to analyze, interpret, list, and the like for all the features described herein for users of recruiting system 100.

Also, computing devices 110, 112 and/or computing devices 118 may include a memory system 408 and a power source 410 (e.g., a battery or other power source). Additionally, computing devices 110, 112 and/or computing devices 118 may include a storage device 412, which may along with memory system 408 store some or all data associated with recruiting system 100.

Further, computing devices 110, 112 and/or computing devices 118 may include an audio and/or video unit 414 for emitting audio signals and displaying video signals. Preferably, computing devices 110, 112 and/or computing devices 118 may include a data transceiver/receiver (transceiver TX/RX) component 416 for transmitting data to and/or receiving data from one or more electronic devices, manufacturers mobile phone application stores, and the like. A bus, computer architecture pathway, (hereinafter referred to as “bus 318”) and the like for all elements/components of recruiting system 100 to communicate with each other and other electronic devices as described herein. Also, computing devices 110, 112 and/or computing devices 118 may include an antenna 420 in communication with TX/RX component 416.

It is understood that recruiting system 100 can be configured for communication with a plurality of external devices, including a wide variety of different types and configurations of electronic devices via wired or wireless links as described herein. Additionally, TX/RX component 416 and antenna 420 of computing devices 110, 112 and/or computing devices 118 may be configured for a plurality of different types of electronic communication.

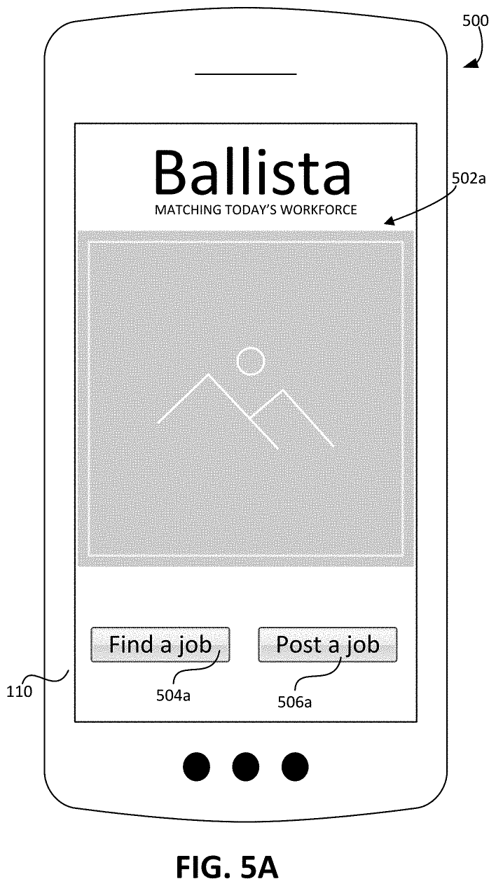

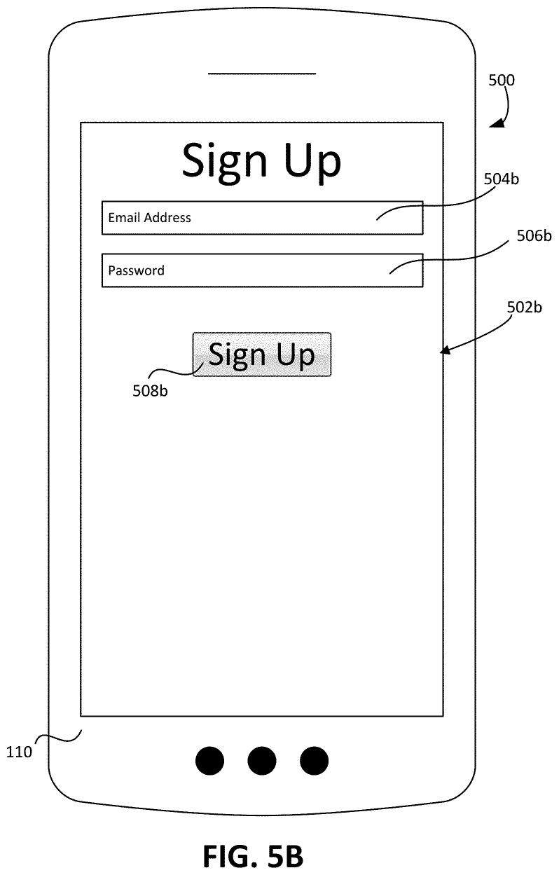

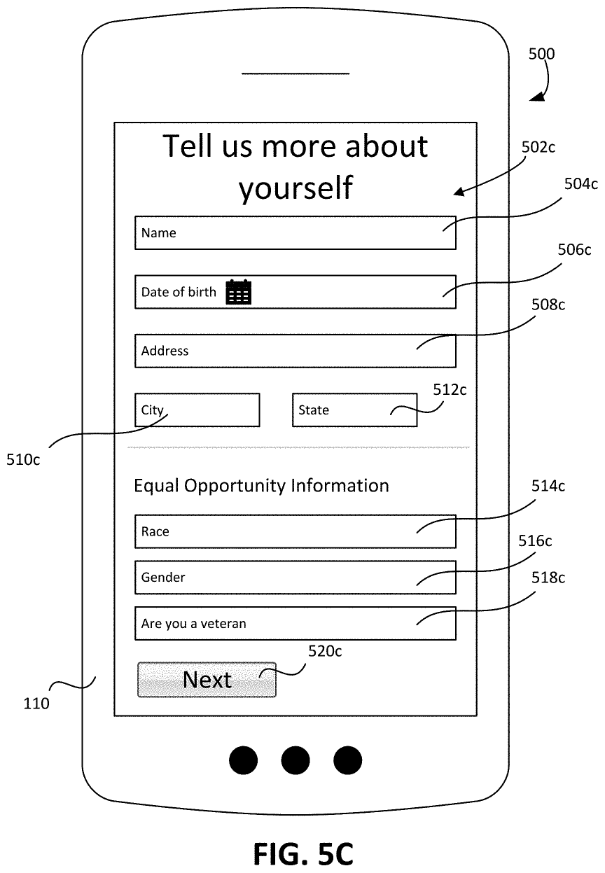

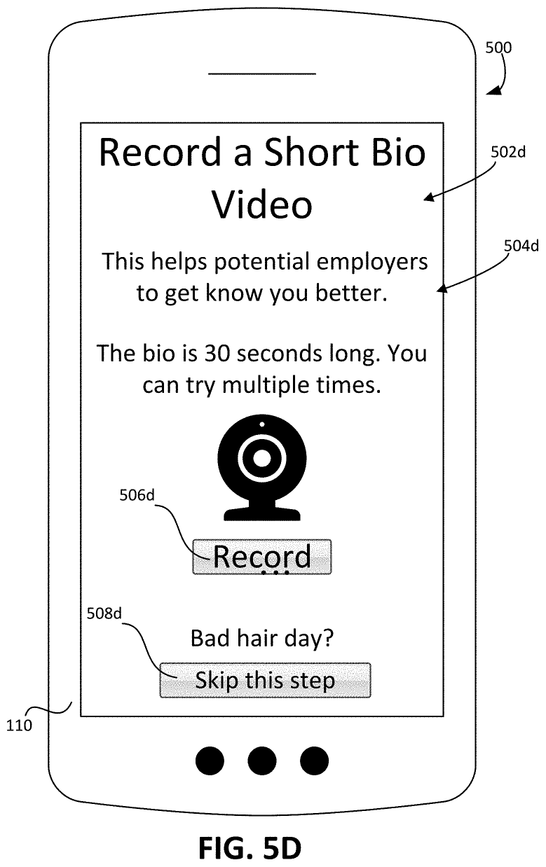

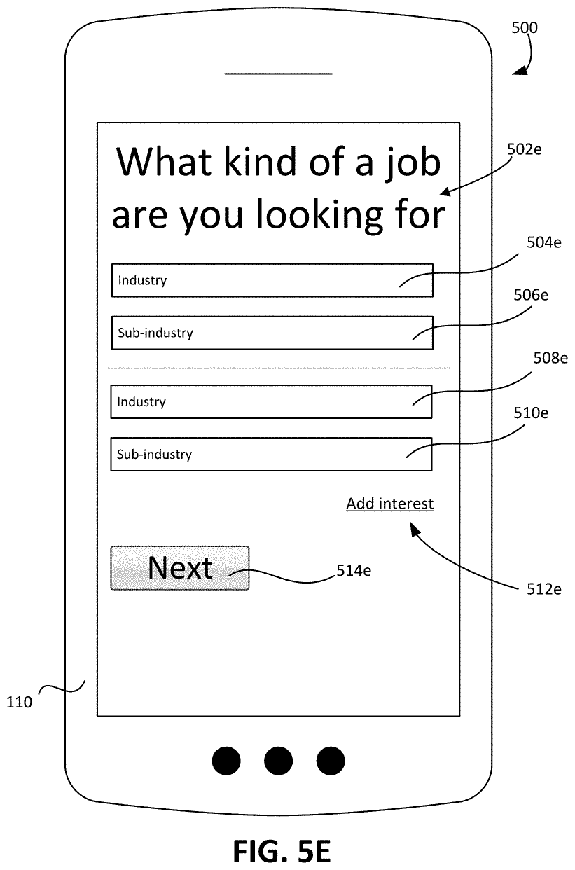

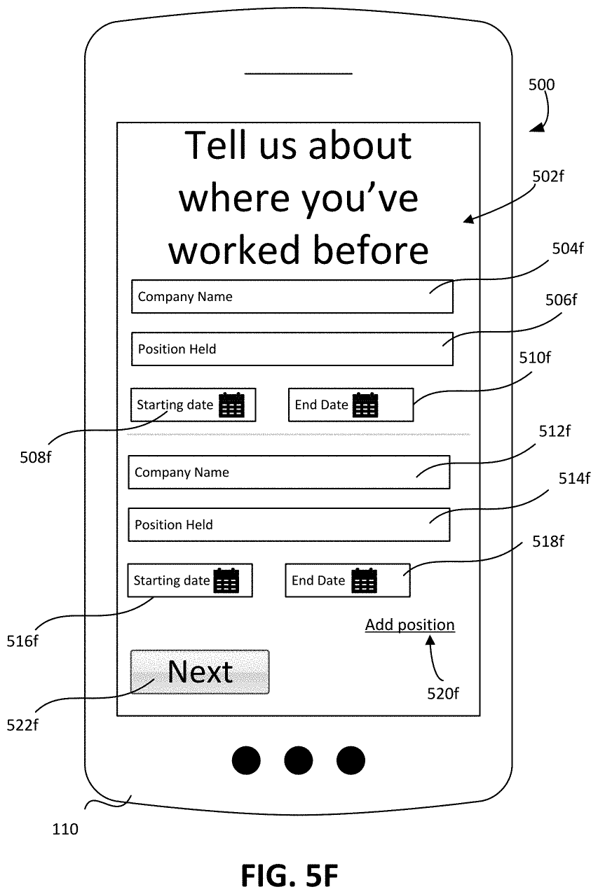

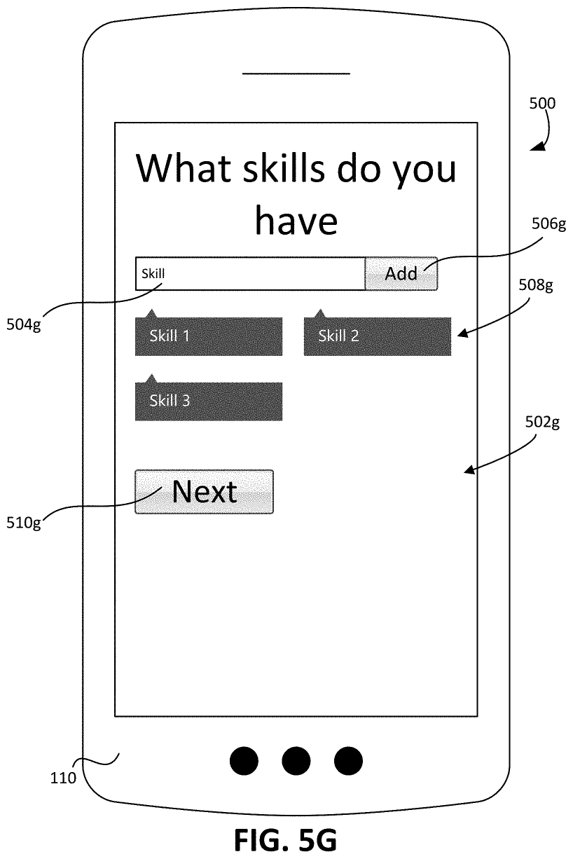

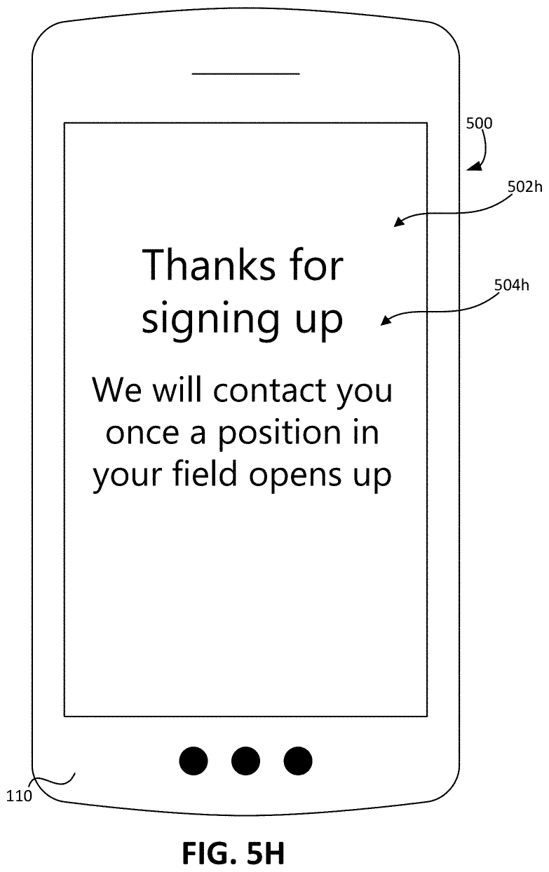

Turning now to FIGS. 5A-5H, recruiting system 100 may display a plurality of graphical user interface screens 500 (hereinafter “GUI screens 500”) to computing devices 110, 112 and/or computing devices 112 users of recruiting system 100. Typically, GUI screens will be displayed on computing devices 110 of candidate 102. With reference to FIG. 5A, GUI screens 500 may include welcome screen 502a for a user to find a job or post a job into recruiting system 100. In one example, welcome screen 502a may include a “find a post” button 504a for clicking on by a user of recruiting system 100 to find a job posting. Additionally, welcome screen 502a may include a “post a job” button 506a for clicking on by a user of recruiting system 100 to post a job for candidates to find. Typically, GUI screens displaying data and information relating to candidate 102 may be displayed on computing devices 110, while GUI screens displaying data and information relating to hiring authority 104 and its users, such as users 106, may be displayed to computing devices 112. Additionally, servers 108 may have such GUI screens displayed on computing devices 118.

Turning now to FIG. 5B, computing devices 110 may display a candidate sign-up screen 502b for candidate 102 to sign-up with recruiting system 100. Candidate sign-up screen 502b may display an email address field 504b and password field 506b to candidate 102 for signing up with recruiting system 100. When the term “field” is used herein, it is meant to broadly cover all data fields, input fields, data inputs, and the like that one skilled in the art would understand. Additionally, candidate sign-up screen 502b may display a sign-up button 508b for clicking by candidate 102 for entering the sign-in information.

Referring now to FIG. 5C, computing devices 110 may display a candidate information screen 502c for candidate 102 to input additional information regarding their background, such as biographical information, into recruiting system 100. Additional candidate screen 502c may display a name field 504c, a date of birth field 506c (and/or pop up calendar), an address field 508c, a city field 510c, a state field 512c, a race field 514c, a gender field 516c, a veteran status field 518c, and the like. A convenient next button 520c may be displayed on additional candidate screen 502c once candidate 102 for entering their information into recruiting system 100 and presenting the next GUI screen, for example.

Referring now to FIG. 5D, computing devices 110 may display a record bio screen 502d to a user, such as candidate 102, giving them the functionality of recording a video of themselves to be seen by hiring authority 104, for example. Record bio screen 502d may also display a message 504d giving instructions for candidate 102 to record the video. Record bio screen 502d may also include a recording button 506d that may activate computing devices' 110, 112 camera for recording such a video. Record bio screen 502d may also include a skip button 508d enabling candidate 102 to skip recording a video “elevator pitch.”

Referring now to FIG. 5E, computing devices 110, 112 may display to candidate 102 a job category screen 502e that displays selectable industries and sub-industries to candidate 102 for selecting. For example, job category screen 502e may display an industry field or dropdown box (“industry field 504e”) to candidate 102 for selecting the industry or position candidate 102 is looking for employment. Additionally, job category screen 502e may display a sub-industry field or dropdown box (“sub-industry field 506e”) to candidate 102 for selecting a sub-industry or position candidate 102 is looking for employment. Job category screen 502e may also display one or more additional industry and sub-industry field, such as industry field 508e and sub-industry field 510e. These fields are populated or accept commonly known industries and sub-industries to enable recruiting system 100 to match properly jobs posted by hiring authority 104 and jobs sought by candidate 102, for example.

Job category screen 502e may also display to candidate 102 and add interest link 512e that when selected by candidate 102 another screen is displayed on computing devices 110 for entering additional interests candidate 102 may have. Job category screen 502e may also display a next button 514e that when selected by candidate 102 an additional screen may be displayed, such as shown in FIG. 5F.

FIG. 5F additional fields and buttons for inputting data and information about candidate 102 for viewing by hiring authority 104. As shown in FIG. 5F, computing devices 110 may display to candidate 102 a work experience screen 502f for inputting past and current work experiences. Work experience screen 502f may display a company name field 504f for inputting by candidate 102 the company name of a past or present company they have worked for. Work experience screen 502f may also display a position held field 506f to candidate 102 for inputting their position and/or title at that particular company. Additionally, work experience screen 502f may display to candidate 102 field for entering their start and end dates of employment, such as found in starting date input field or dropdown box (“starting date input field 508f”) and end date input field or dropdown box (“end date input field 510f”), for example.

Work experience screen 502f may also include one or more work experience fields for input by candidate 102, such as company name field 512f, position held field 514f, starting date field 516f, and end date field 518f, for example. Work experience screen 502f may further display a selectable link 520f for displaying additional screens and/or fields for inputting past and present work experience by candidate 102. Work experience screen 502f may further display a next button 522f for forwarding to additional input screens and fields as described below.

Turning now to FIG. 5G, computing devices 110 may further display a skills screen 502g for displaying additional input fields to candidate 102 for entry. Skills screen 502g may display skill field 504g for inputting a particular skillset of candidate 102. Skills screen may further display an add button 506g for adding additional skillsets of candidate 102. Skills screen 502g may further display to candidate 102 the completed skillsets that he/she has completed or may want to add via skillset buttons 508g. Skills screen may further include a next button 510g for selecting by candidate 102 to proceed to a completion screen 502h as shown in FIG. 5H. This screen may further display to candidate 102 a message 504h relating to the status of the process of completing the candidate's inputs.

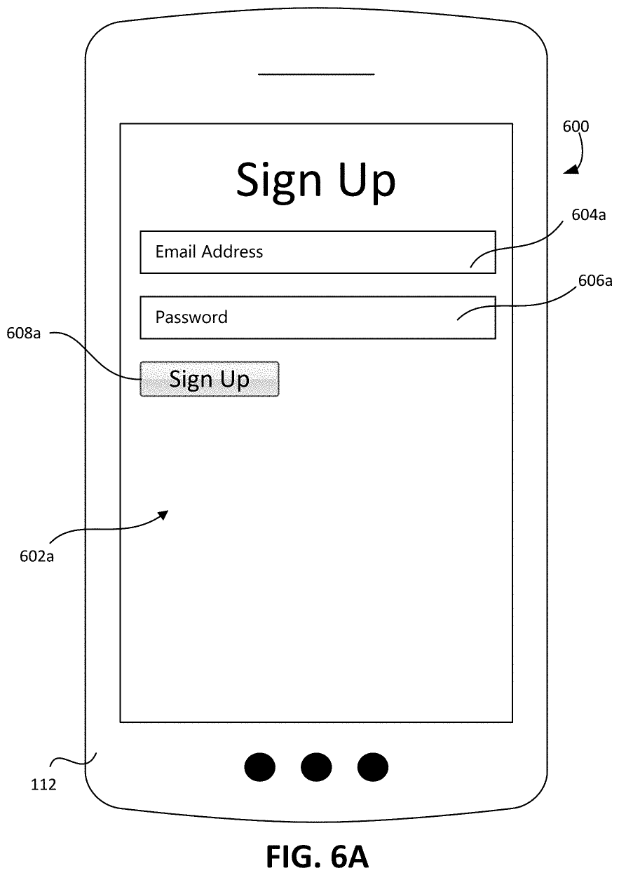

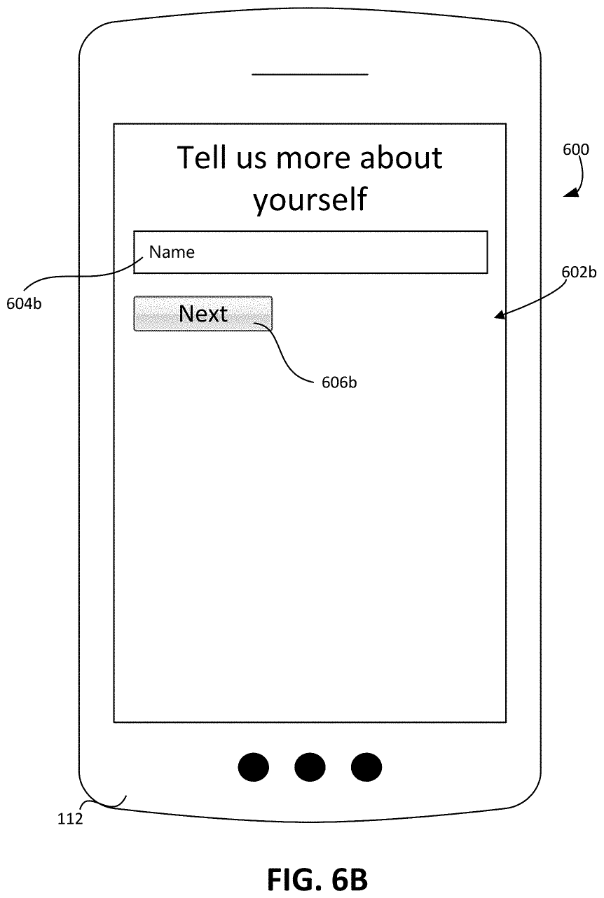

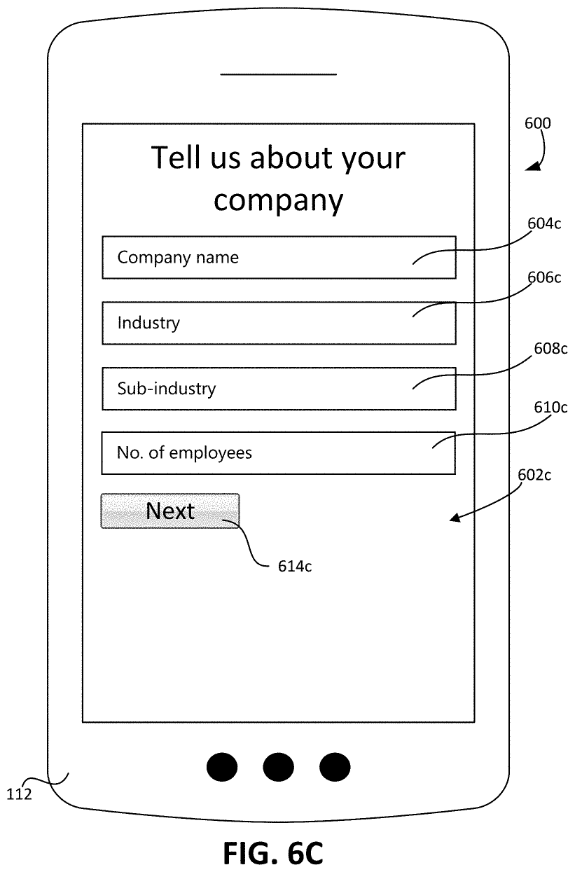

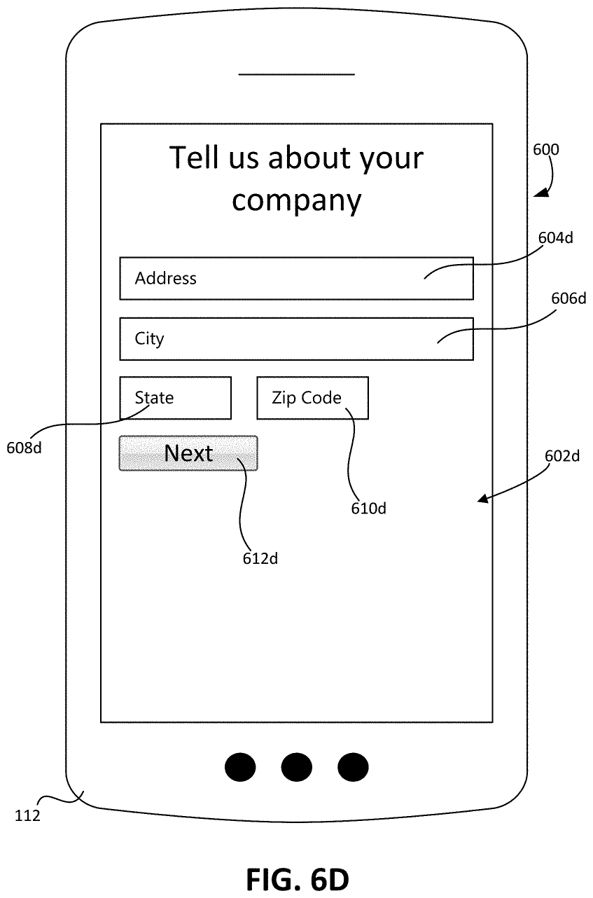

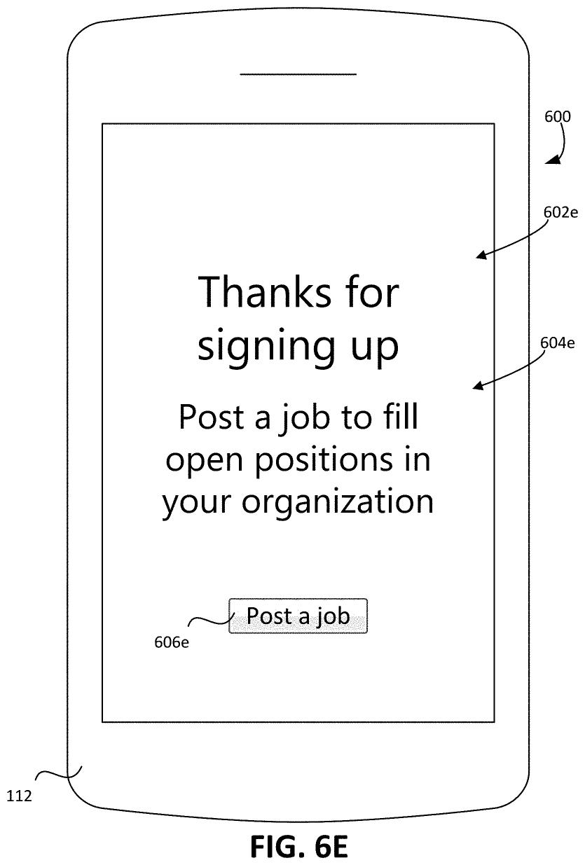

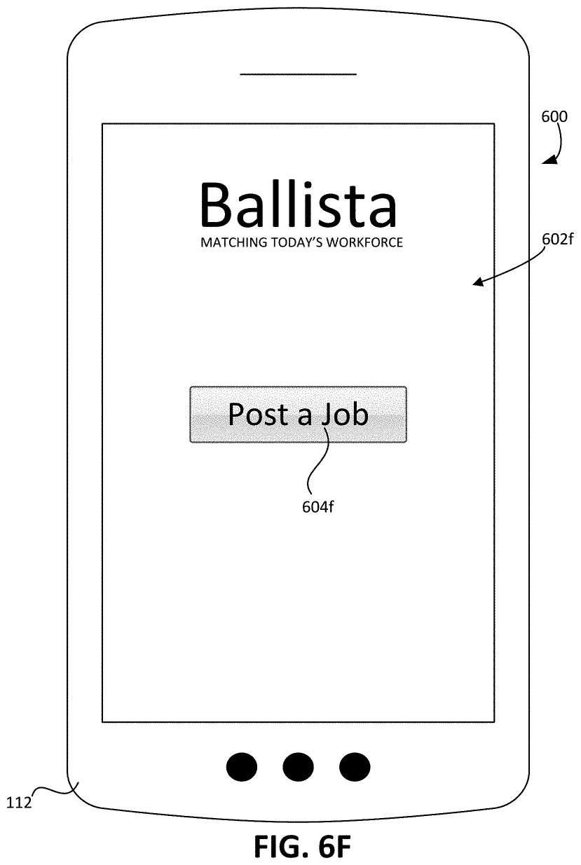

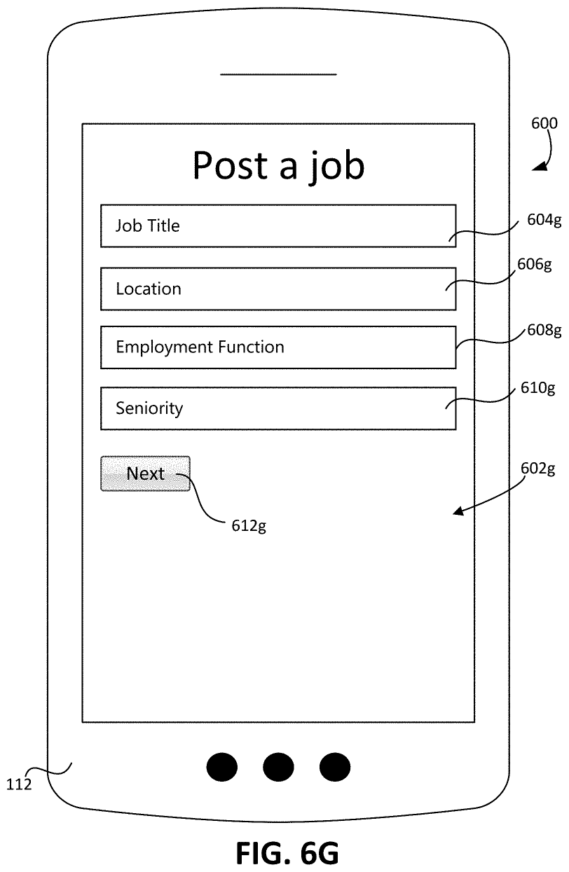

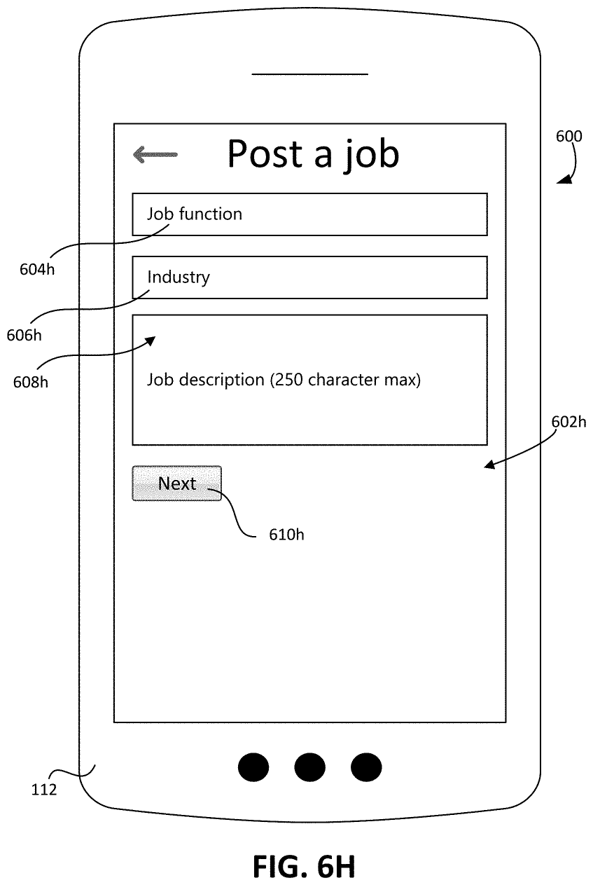

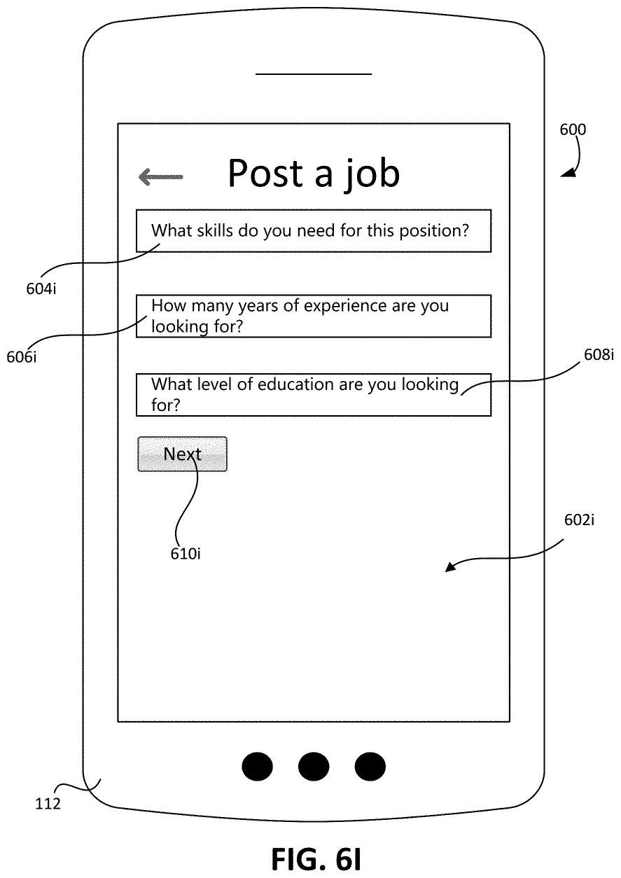

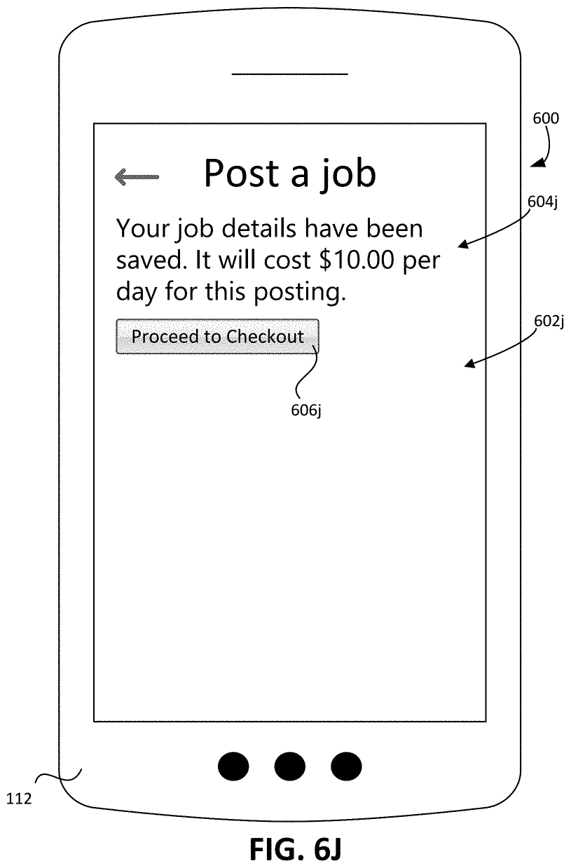

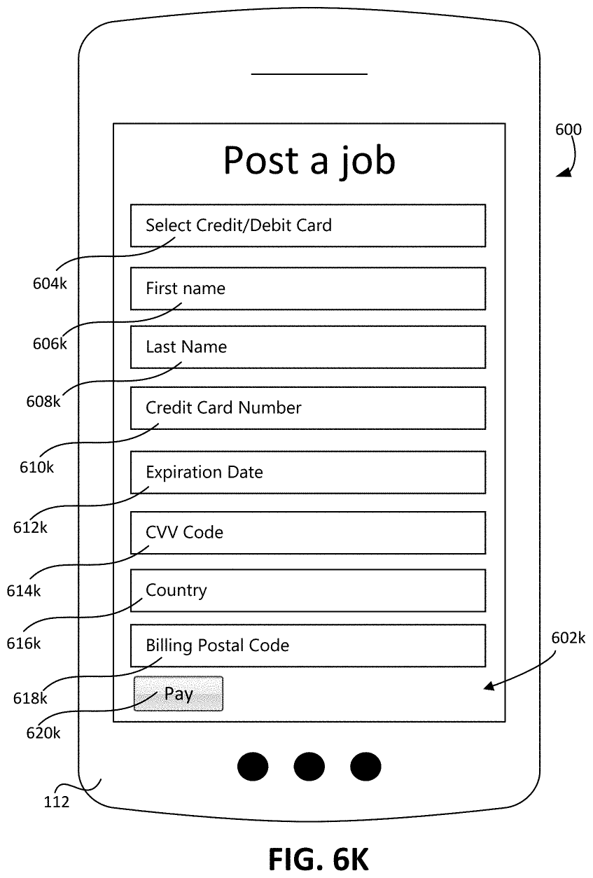

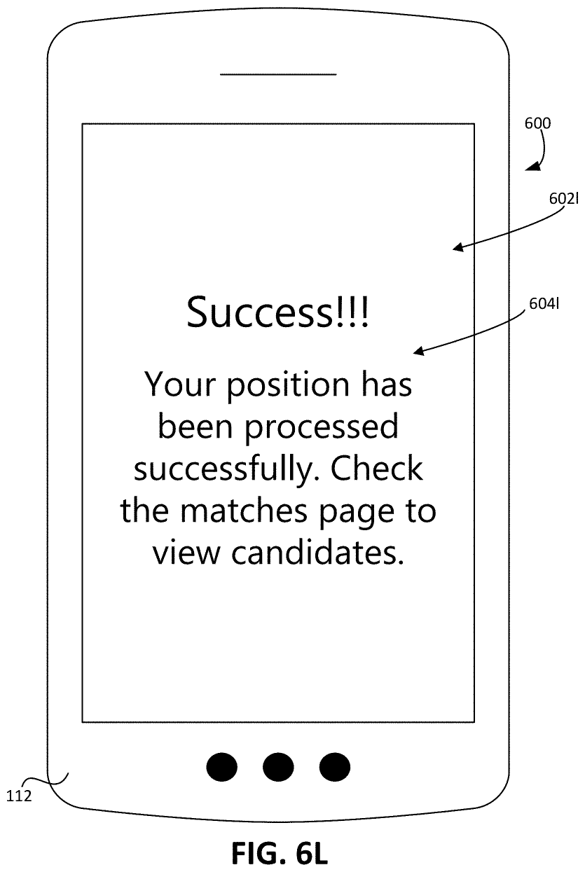

Turning now to FIGS. 6A-6L, recruiting system 100 may display a plurality of GUI screens 600 (hereinafter “GUI screens 600”) to computing devices 110 of recruiting system 100. Typically, GUI screens will be displayed on computing devices 112 of users 106. Referring now to FIG. 6A, computing devices 112 may display a sign up or login screen 602a to hiring authority 104 for signing up with or logging into recruiting system 100. This screen may be displayed when the post a job button 506a is selected by hiring authority 104, in one example. Login screen 602a may display an email address field 604a for entering an email address associated with hiring authority 104. Login screen 602a may display a password field 606a for entering a password associated with the signup or login of hiring authority 104. Login screen 602a may also display a signup button 608a for selecting by hiring authority 104 when signing up or logging into recruiting system 100.

With reference to FIG. 6B, computing devices 112 may display a user input screen 602b for entering in name field 604b the name of users 106 at hiring authority 104, for example. Additionally, user input screen 602b may include a next button 606b for selecting by users 106 to proceed to one or more next screens as described below.

Turning to FIG. 6C, computing devices 112 may display to users 106 a company information screen 602c that requests additional information relating to hiring authority 104. For example, company information screen 602c may display a company name field 604c, an industry field 606c, a sub-industry field 608c, and a number of employees field 610c to users 106 at hiring authority 104. This data and information may be inputted into recruiting system 100 by users 106 at hiring authority 104. Company information screen 602c may further include a next button 614c that can be selected by users 106 for advancing to additional screens of recruiting system 100.

Referring now to FIG. 6D, computing devices 112 may display a company information screen 602d including address field 604d, city field 606d, state field 608d, and zip code field 610d for inputting this information about hiring authority 104, for example. Company information screen 602d may also include a next button 612d that can be selected by users 106 for advancing to a completion screen 602e that may include a message 604e about the status of the inputs into recruiting system 100, as best shown in FIG. 6E. Company information screen 602e may further include a post a job button 606e for advancing to the job post screens of recruiting system 100 as further defined below.

With reference to FIG. 6F, computing devices 112 may display to users 106 a post a job screen 602f that may include a post a job button 604f. Turning to FIG. 6G, computing devices 112 may display a job information screen 602g to users 106 including a job title field 604g, a location field 606g, an employment function field 608g, and a seniority field 610g for entering such related information by users 106 relating to the job they are posting, for example. Job screen 602g may further include a next button 612g for selecting after the information above has been entered to advance to the one or more additional screens.

Referring to FIG. 6H, computing devices 112 may display an additional post a job screen 602h that may include a job function field 604h, an industry field 606h, and a text field 608h for entering this related data and information. Text field 608h may be entered in freestyle to provide additional information relating to the job post for candidate 102 to view later as described further below. Job screen 602h may further include a next button 610h for selecting by users 106 for advancing to additional screens to enter additional information relating to the job.

With reference to FIG. 6I, computing devices 112 may display to users 106 an additional job post screen 602i for requesting additional information about the job post. For example, job post screen 602i may display a skills needs field 604i, years of experience field 606i, and level of education field 608i for inputting such relevant information by users 106 of hiring authority 104. Additionally, job post screen 602i may display a next button 610i for selecting by users 106 for advancing to additional screens related to the job post.

Referring to FIG. 6J, computing devices 112 may display a cost message screen 602j with information 604j relating to the cost of posting the job with recruiting system 100. Further, cost message screen 602j may display a proceed to checkout button 606j that is selectable by users 106 for entering payment information as described further below.

With reference to FIG. 6K, computing devices 112 may display a payment screen 602k for entering payment information. For example, payment screen 602k may display a select card type field 604k, a first name field 606k, a last name field 608k, a card number field 610k, an expiration date field 612k, a security code field 614k, a country code 616k, and a billing postal code field 618k, for example. These fields accept this typical information related to credit/debit card payments and may be inputted by users 106 of hiring authority 104. Additionally, payment screen may display a pay button 620k for selecting by users 106 once the information is entered to start the processing of the payment information. FIG. 6L displays computing devices' 112 payment status screen 6021 with a message 6041 stating whether the payment processed, in one example.

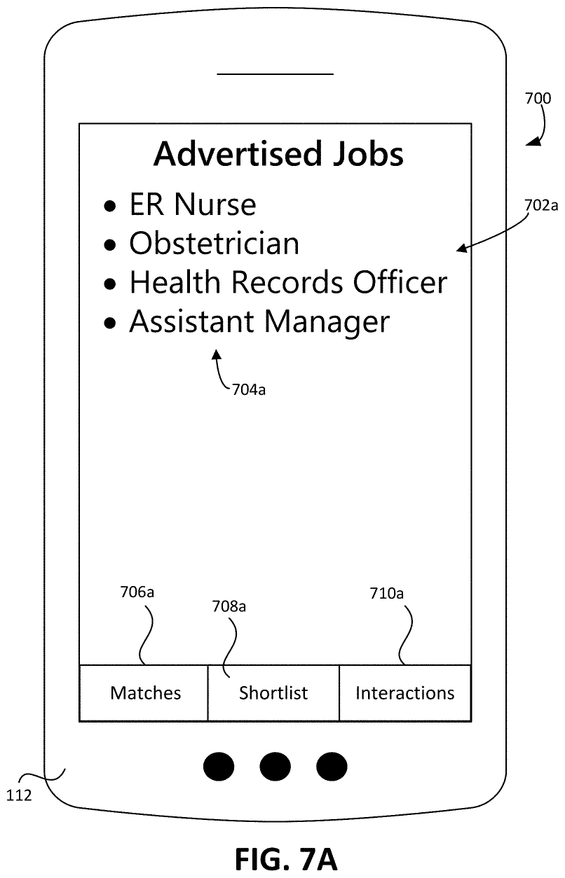

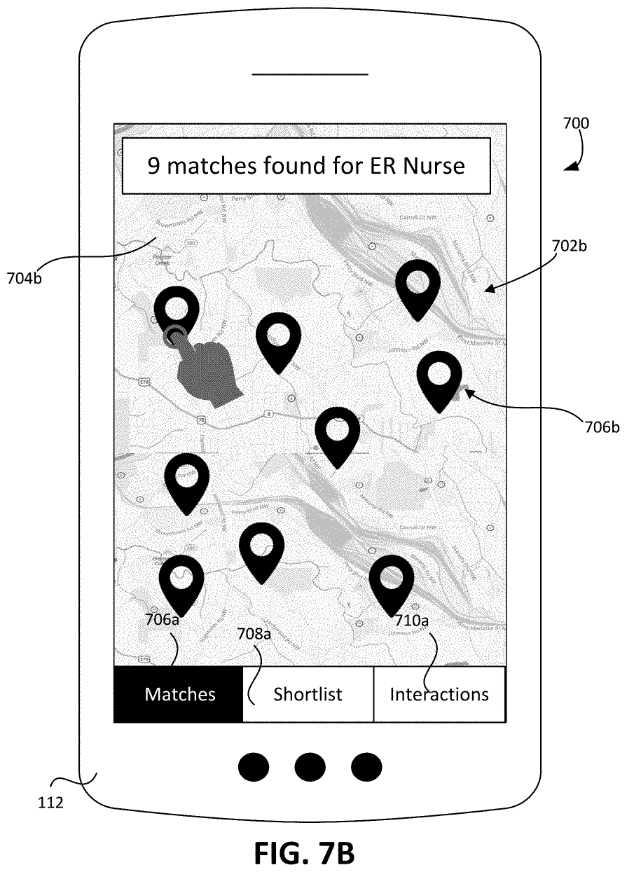

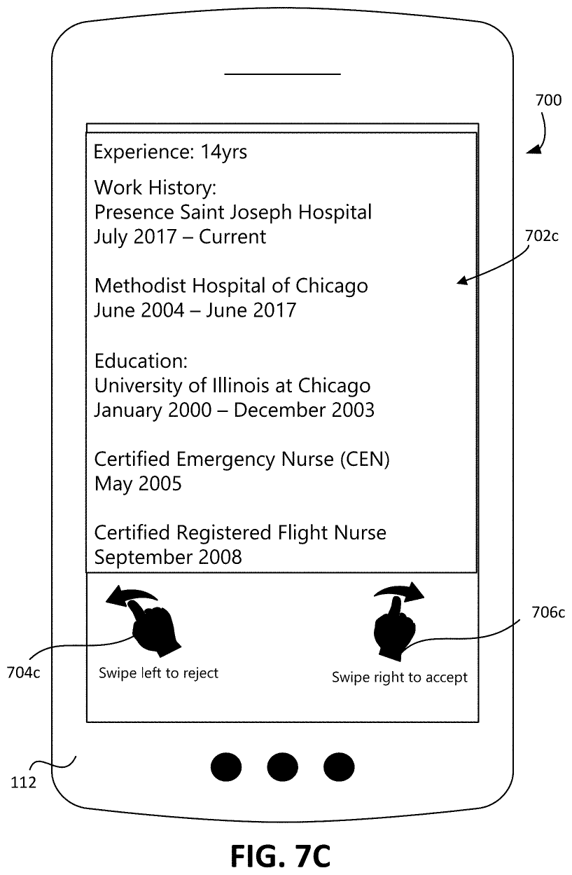

Turning now to FIGS. 7A-7C, recruiting system 100 may display a plurality of GUI screens 700 (hereinafter “GUI screens 700”) to computing devices 112 of recruiting system 100. With reference to FIG. 7A, computing devices 112 may display to users 106 of hiring authority 104 an advertised jobs screen 702a that displays a listing 704a of the one or more job postings they have created. Advertised jobs screen 702a may also display a matches button 706a, a shortlist button 708a, and an interactions button 710a, for example.

Referring now to FIG. 7B, when a particular advertised job, such as “ER Nurse” is selected by users 106, and the matches button 706a is selected, then a matches map screen 702b is displayed on computing devices 112 to users 106 of hiring authority 104. Matches map screen 702b displays a matches map 704b that may be defined in size and/or geographical location by users and it displays the matches of candidate 102 (“candidate matches or indicia 706b”) who are looking for a job that have skills that recruiting system 100 has matched to the job posting as described herein. As shown in FIG. 7B, there are 9 indicia 706b of candidate matches shown geographically as indicia on matches map 704b. In this embodiment, matches button 706a is highlighted as best shown in this figure.

Users 106 may then click on any of the indicia 706b of the matched candidates and candidate information screen 702a may be displayed on computing devices 112, as best shown in FIG. 7C. Typically, the candidate information that is displayed at this time is just non-personal identifying information and only work experience, skillsets, education, and the like is displayed to prevent any bias in selecting the candidate for an interview, in one embodiment. As discussed further below, if users 106 and/or hiring authority 104 reject a candidate at this point, then candidate information screen 702a may display a reject button 704c for selecting and/or swiping to reject the candidate. Additionally, candidate information screen 702a may also display an accept button 706c for selecting and/or swiping to accept the candidate. Any other selectable buttons, fields, and the like may be used in place of the swipable buttons as described herein. Similarly, the indicia 706b shown on matches map 704b may be matched hiring authorities that are displayed to one or more candidate 102.

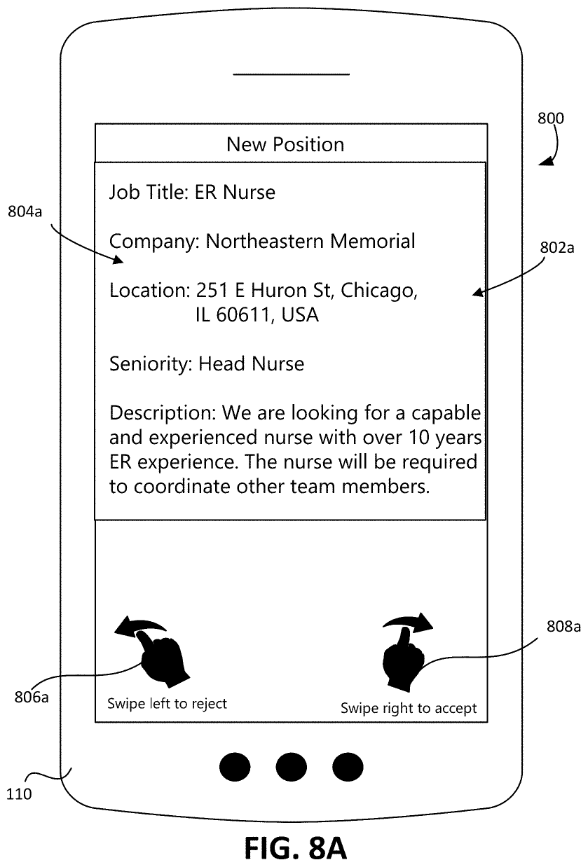

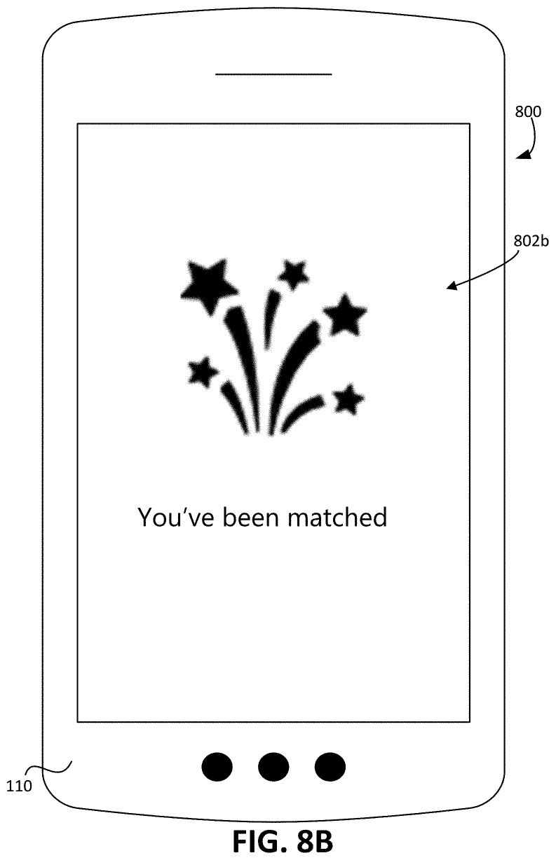

Turning now to FIGS. 8A-8B, recruiting system 100 may display a plurality of GUI screens 800 (hereinafter “GUI screens 800”) to computing devices 110 of recruiting system 100. As described further below, if candidate 102 is accepted, then recruiting system 100 may display on computing devices 110 of candidate 102 a new position screen 802a. New position screen 802a may display data and information for the job posting that candidate 102 was accepted above. As described above, new position screen 802a may display swipable, movable, selectable, and the like buttons, such as reject button 806a and accept button 808a for candidate 102 to either inform recruiting system 100 that they have rejected or accepted the job posting.

Referring now to FIG. 8B, computing devices 110 may display on a congratulations screen 802b that both candidate 102 and hiring authority 104 (and/or users 106) have matched.

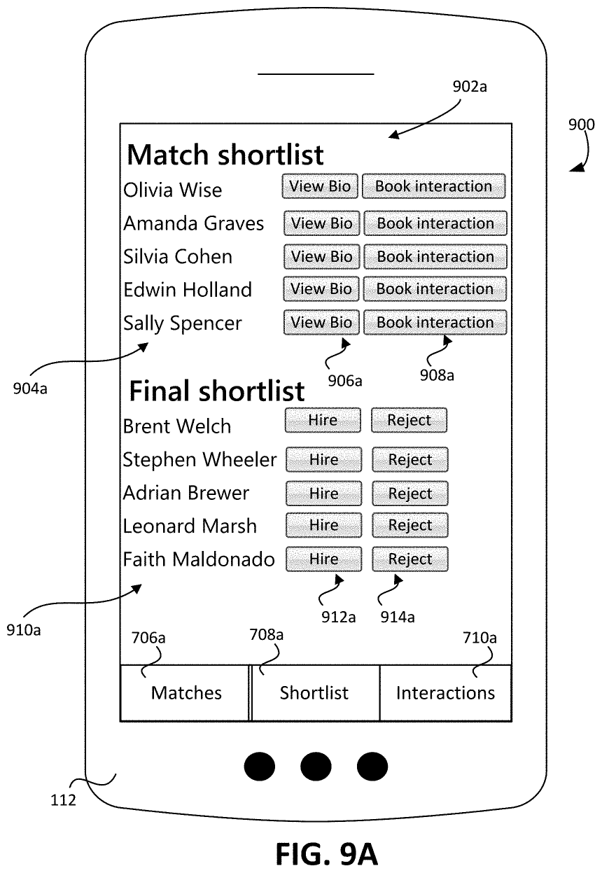

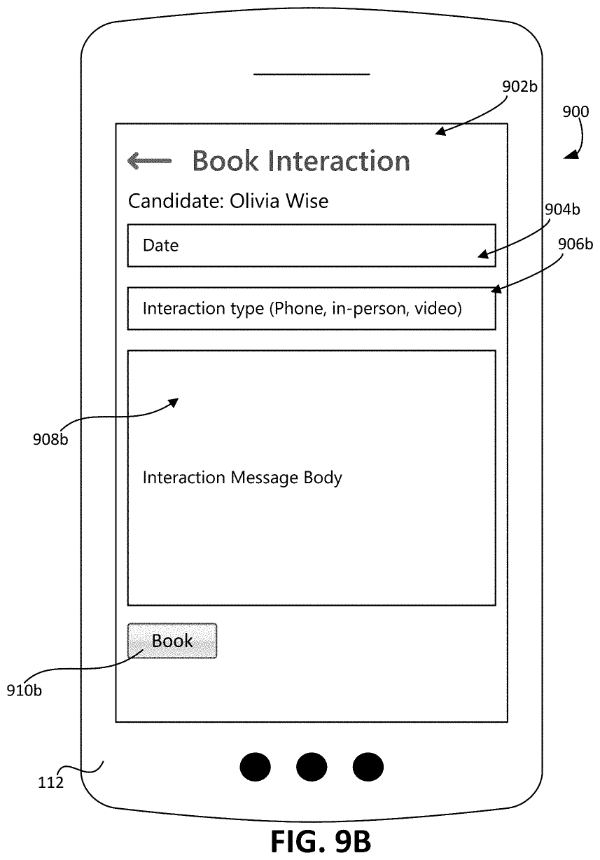

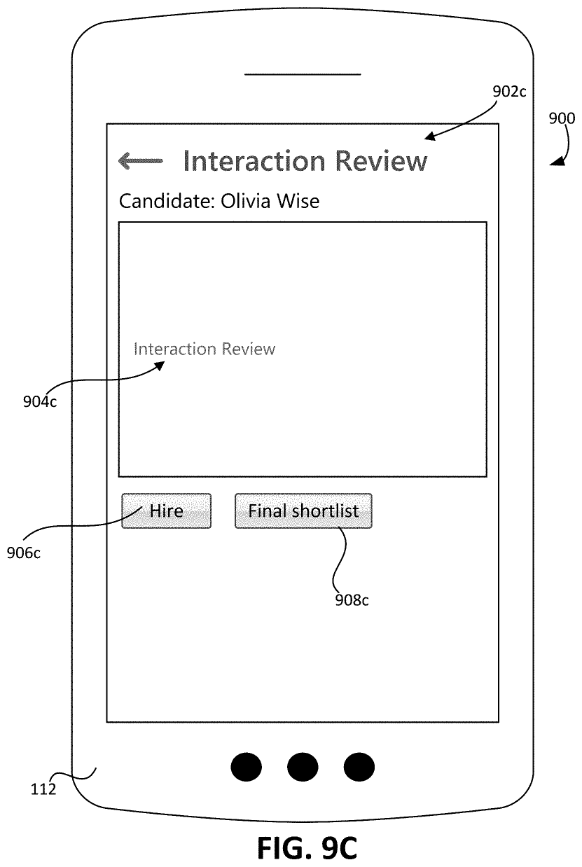

Turning now to FIGS. 9A-8B, recruiting system 100 may display a plurality of GUI screens 900 (hereinafter “GUI screens 900”) to computing devices 112 of recruiting system 100. With reference to FIG. 9A, computing devices 112 may display to users 106 a shortlist screen 902a that displays data and information regarding candidates 102 that have matched with hiring authority 104 job posting as described herein. Shortlist screen 902a may display a listing 904a of shortlist candidates 102 and a selectable view bio button 906a next to each listed candidate 102. By selecting view bio button 906a, the biographical information is displayed to users 106 of hiring authority 104. Shortlist screen 902a may also display a book interaction button 908a next to each listed candidate 102 for booking an interview with the candidate 102 as further described herein.

Shortlist screen 902a also may display a listing 910a of candidates 102 who may have been interviewed and now it's time to make a hiring decision. Shortlist screen 902a may display a hire button 912a and a reject button 914a next to each final shortlist candidate 102 in listing 910a, for example.

Turning now to FIG. 9B, computing devices 112 may a book interaction screen 902b for facilitating the interview and/or interaction between candidate 102 and hiring authority 104, for example. Book interaction screen 902b may display a date field 904b for the interview and/or interaction between candidate 102 and hiring authority 104. Book interaction screen 902b may also display an interaction type field 906b. This field is for selecting whether the interaction is via telephone, in-person, etc. Book interaction screen 902b may further display to a user an interaction message field 908b for inputting any additional comments relating to the scheduled interaction. Book interaction screen 902b may also display a book button 910b for completing the booking of the interaction between candidate 102 and hiring authority 104.

Referring now to FIG. 9C, computing devices 112 may display an interaction review screen 902c that may be completed by hiring authority 104 after the interaction between candidate 102 and hiring authority 104 has occurred. Interaction review screen 902c may display an interaction review field 904c for inputting impressions of hiring authority 104 about the interaction with candidate 102, for example. Interaction review screen 902c may further display a hire button 906c that may be selected if hiring authority 104 wishes to commit to hiring candidate 102. Interaction review screen 902c may further include a final shortlist button 908c for putting candidate 102 onto the shortlist as described herein.

In addition to the above, recruiting system 100 provides inputs for selecting by either candidate 102 and/or users 106 and/or hiring authority 104 the percentage of a match criteria, such as geographical location size, specific title matches, etc. If there is not that many jobs in geographical area, then they can back off the match criteria, such as 75%, and each percentage may have a color code and each job will be represented as a pin dot on a geographical map as described above.

Candidate 102 and/or users 106 and/or hiring authority 104 then may click on a pin dot, such as indicia 706b of candidate matches, and that job interface opens up showing the company name, pay that will be payed.

Another feature of recruiting system 100, is that it provides hiring authority 104 who may have a job to fill that is critical to blast out the communication or job posting to those having acceptable qualifications within a geographical area. This may also be a fee based functionality of recruiting system 100.

One benefit of recruiting system 100 is that it communicates bite sized information to candidate 102 and/or hiring authority 104 to promote continued or continuing interest between the parties.

Another feature of recruiting system 100 is that any travel arrangements can be selected and paid for through the application with hiring authority 104 information on file, saving candidates from going through reimbursement hassles.

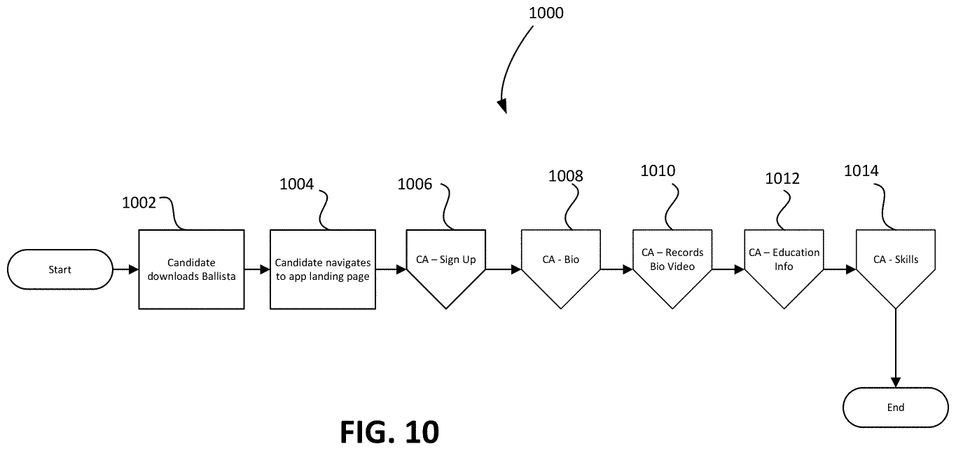

The present interactive systems and methods for recruiting candidates may further include methods for matching candidates and hiring authorities, and the like. Referring now to FIG. 10, an embodiment of a method for a candidate to sign up for recruiting system 100 and enter their biographical information is generally illustrated and generally designated 1000. In step 1002, candidate 102 may use any communications and/or computing device, such as computing devices 110, to connect with an online mobile device application store, such as Apple iTunes or Google Store and download and install recruiting system 100 on their communications and/or computing device. This step may also include agreeing to the end user license agreement, as some information relative to FIG. 10 may be obtained by recruiting system 100 for purposes of offering additional features and benefits that a user may desire to have.

In step 1004, candidate 102 may navigate to the application landing page of recruiting system 100. In step 1006, candidate 102 may sign-up for the services and functionalities of recruiting system 100. This step may also include logging into recruiting system 100 application once it's loaded on computing devices 110, for example.

In step 1008, candidate 102 may enter their biographical information into recruiting system recruiting system 100 as described herein. In step 1010, candidate 102 may record their video “elevator pitch” into recruiting system 100 as described herein. In step 1012, candidate 102 may enter their educational background into recruiting system 100. In step 1014, candidate 102 may enter their skills information into recruiting system 100 as described herein.

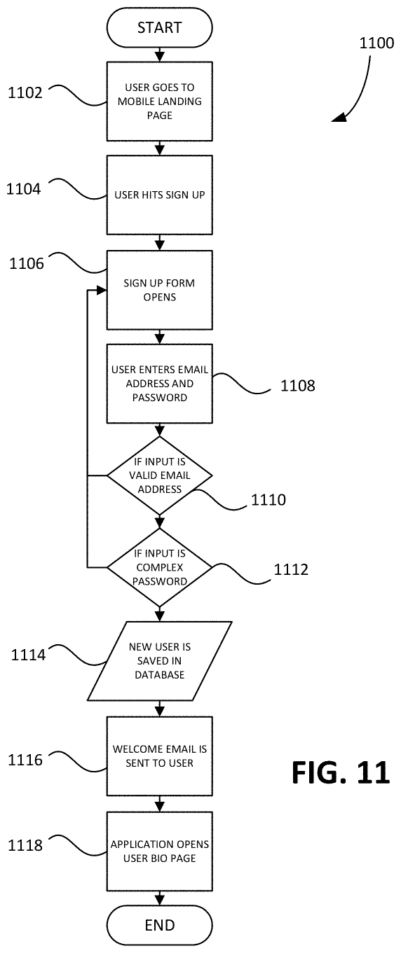

Referring now to FIG. 11, an embodiment of a method for candidate 102 to sign up for recruiting system 100 and is generally illustrated and generally designated 1100. In step 1102, candidate 102 downloads the application of recruiting system 100. This step may include navigating to a landing page of recruiting system 100. In step 1104, candidate 102 selects sign-up if they haven't already signed up for the services and functionality of recruiting system 100. In step 1106, recruiting system 100 may display a sign-up form to candidate's 102 computing devices 110. In step 1108, candidate 102 may enter their email address and password for logging into recruiting system 100.

In step 1110, an inquiry is performed to determine whether recruiting system 100 recognizes or determines that candidate's 102 email address is valid. If the answer to this inquiry is “yes,” then the method may proceed to step 1112. If the answer to this inquiry is “no,” then the method may proceed back to step 1106. In step 1112, an inquiry is performed to determine whether recruiting system 100 recognizes or determines that candidate's 102 password sufficiently complex for security purposes to proceed. If the answer to this inquiry is “yes,” then the method may proceed to step 1114. If the answer to this inquiry is “no,” then the method may proceed back to step 1106. In step 1114, the candidate 102 is signed up and saved in the database(s) of recruiting system 100. In step 1116, a welcome email may be sent by recruiting system 100 to candidate 102 notifying them of the successful sign-up for the services and functionality of recruiting system 100. In step 1118, recruiting system 100 opens the biographical page of candidate 102 for completing.

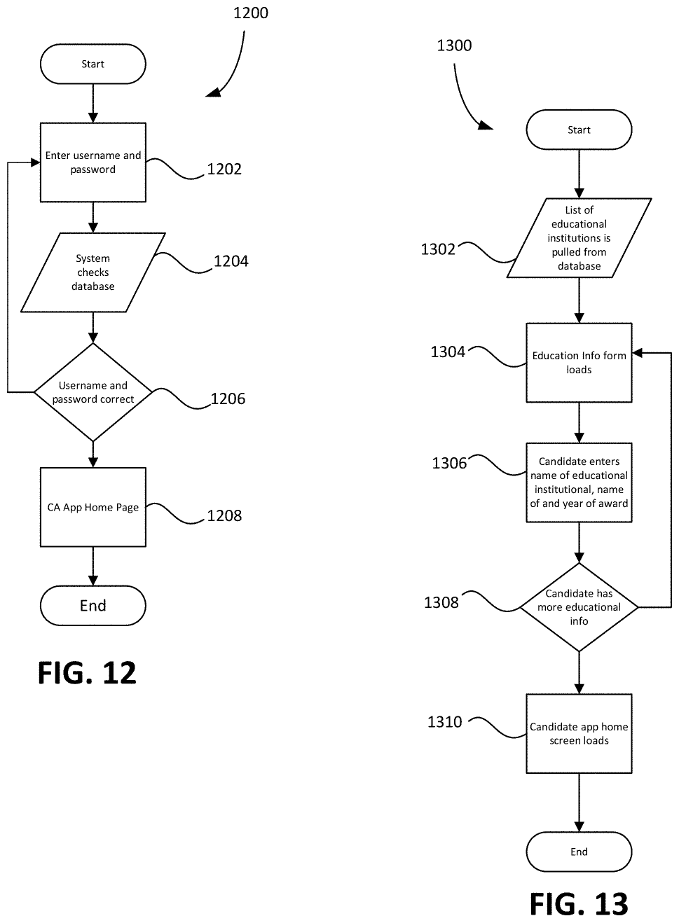

Referring now to FIG. 12, an embodiment of a sign-in process for candidate 102 to recruiting system 100 and is illustrated and generally designated 1200. In step 1202, candidate 102 enters their username, email address, password, etc. to login to recruiting system 100. In step 1204, recruiting system 100 verifies information with databases. In step 1206, an inquiry is performed to determine whether recruiting system 100 recognizes login information of candidate 102. If the answer to this inquiry is “yes,” then the method may proceed to step 1208. If the answer to this inquiry is “no,” then the method may proceed back to step 1202. In step 1208, recruiting system 100 displays candidates home page on computing devices 110.

Referring now to FIG. 13, an embodiment of a method for entering educational information for candidate 102 to recruiting system 100 and is illustrated and generally designated 1300. In step 1302, a list of educational institutions is pulled from the database that may be populated into a dropdown box for candidate 102 to easily click on their educational institutions. In step 1304, the educational form or screen is displayed to candidate 102. In step 1306, enters the name of educational institution, degree, and date of award, for example.

In step 1308, an inquiry is performed to determine whether candidate 102 has additional educational information to enter into recruiting system 100. If the answer to this inquiry is “yes,” then the method may proceed to step 1304. If the answer to this inquiry is “no,” then the method may proceed to step 1310. In step 1310, the home screen of recruiting system 100 may be displayed to computing devices 110 of candidate 102.

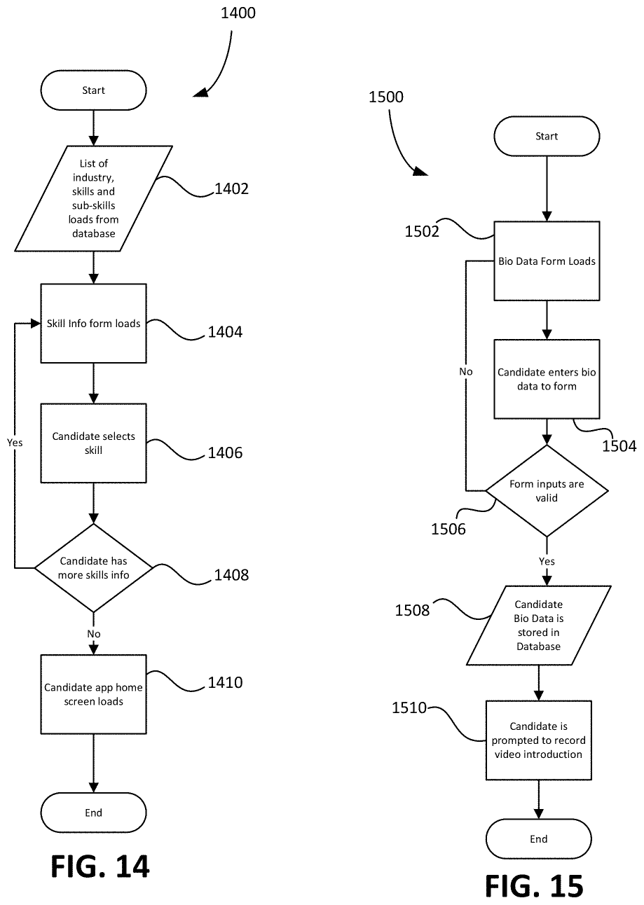

With reference to FIG. 14, an embodiment of a method for entering skill information for candidate 102 to recruiting system 100 and is illustrated and generally designated 1400. In step 1402, a list of industry skills and sub-skills is loaded into the application from a database of recruiting system 100. In step 1404, this information may be then loaded into a form or screen as described herein for viewing by candidate 102. In step 1406, candidate 102 selects those skills and sub-skills of candidate 102 from the display or screen of computing devices 110, for example. In step 1408, an inquiry is performed to determine whether candidate 102 has additional skill information to enter into recruiting system 100. If the answer to this inquiry is “yes,” then the method may proceed to step 1404. If the answer to this inquiry is “no,” then the method may proceed to step 1410. In step 1410, the home screen of recruiting system 100 may be displayed to computing devices 110 of candidate 102.

With reference to FIG. 15, an embodiment of a method for entering biographical information for candidate 102 to recruiting system 100 and is illustrated and generally designated 1500. In step 1502, recruiting system 100 displays a biographical data form or screen on candidate's 102 computing devices 110. This step may include populating some fields or dropdown boxes with common information. In step 1504, candidate 102 enters their biographical information into forms or screens as described herein. In step 1506, an inquiry is performed to determine whether the biographical information entered into recruiting system 100 by candidate 102 is valid. If the answer to this inquiry is “yes,” then the method may proceed to step 1508. If the answer to this inquiry is “no,” then the method may proceed to step 1502. In step 1508, the biographical data or information is stored in a database of recruiting system 100. In step 1510, recruiting system 100 may prompt candidate 102 to record a video of themselves for uploading to recruiting system 100 for future viewing by hiring authority 104.

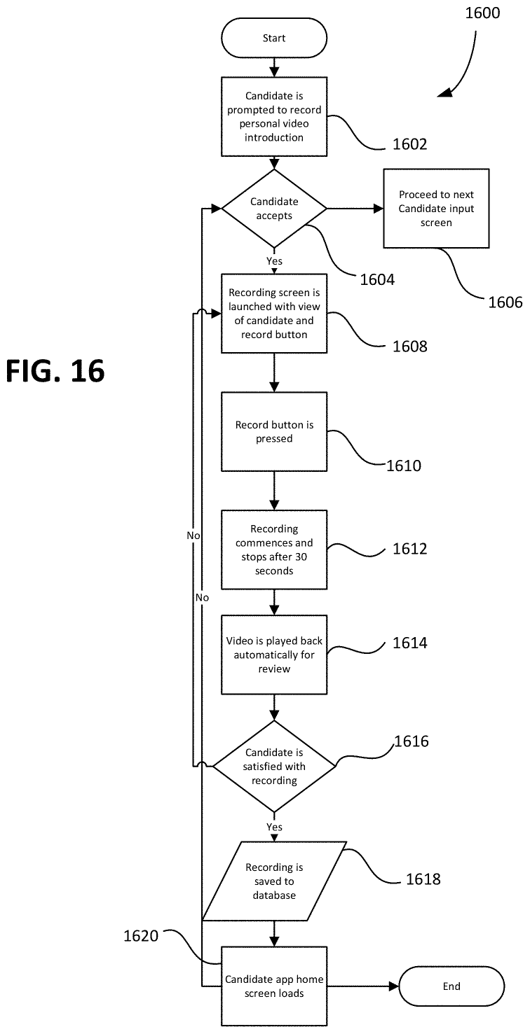

Turning now to FIG. 16, an embodiment of a method for recording a video of candidate 102 to recruiting system 100 and is illustrated and generally designated 1600. Step 1602 may be the same as step 1510 in that recruiting system 100 prompts candidate 102 to record a short video, such as an “elevator pitch,” of themselves. In step 1604, an inquiry is performed to determine whether candidate 102 elected to record a video of themselves. If the answer to this inquiry is “yes,” then the method may proceed to step 1608. If the answer to this inquiry is “no,” then the method may proceed to step 1606 where recruiting system 100 may display another screen to candidate 102. In step 1608, the recording screen is launched as described herein showing the candidate and a recording button for activating by candidate 102. In step 1610, candidate 102 selects or presses the record button.

In step 1612, the candidate's 102 computing device's 110 camera begins to record the video of candidate's 102 “elevator pitch.” The terms “elevator pitch” means any presentation by candidate 102 of their respective skills, education, titles, and the like on why hiring authority 104 should consider hiring them. The duration of the recording may be any time, although if may be preferred if the video is kept to a shorter time, such as 30 seconds or less to keep hiring authority 104 focused on the recording of candidate 102. In step 1614, the recording may be played back to candidate 102 so that they may see if it is acceptable to them. This step may include playing the video automatically upon the recording being finished.

In step 1616, an inquiry is performed to determine whether candidate 102 is satisfied with the recording. If the answer to this inquiry is “yes,” then the method may proceed to step 1618. If the answer to this inquiry is “no,” then the method may proceed to step 1608. In step 1618, the recording is stored to a database of recruiting system 100. In step 1620, the candidate home screen may be loaded or displayed on computing devices 110 to candidate 102.

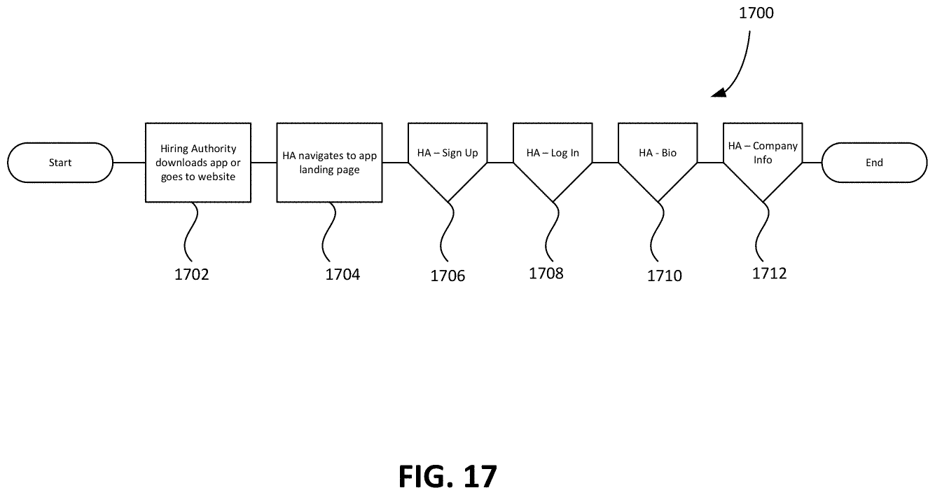

Turning now to FIG. 17, an embodiment of a method for signing up hiring authority 104 to recruiting system 100 is illustrated and generally designated 1700. In step 1702, hiring authority 104 downloads the application of recruiting system 100 as described herein. In step 1704, hiring authority 104 navigates to a landing page of the application of recruiting system 100. In step 1706, a sign-up screen is displayed to computing devices 112 of hiring authority 104 as described herein. Once hiring authority 104 is signed up with recruiting system 100, then in step 1708, a login screen may be displayed to hiring authority's 104 computing devices 112 as described herein. In step 1710, hiring authority 104 enters their biographical information into recruiting system 100 as described herein. In step 1712, hiring authority 104 then enters their company information as described herein.

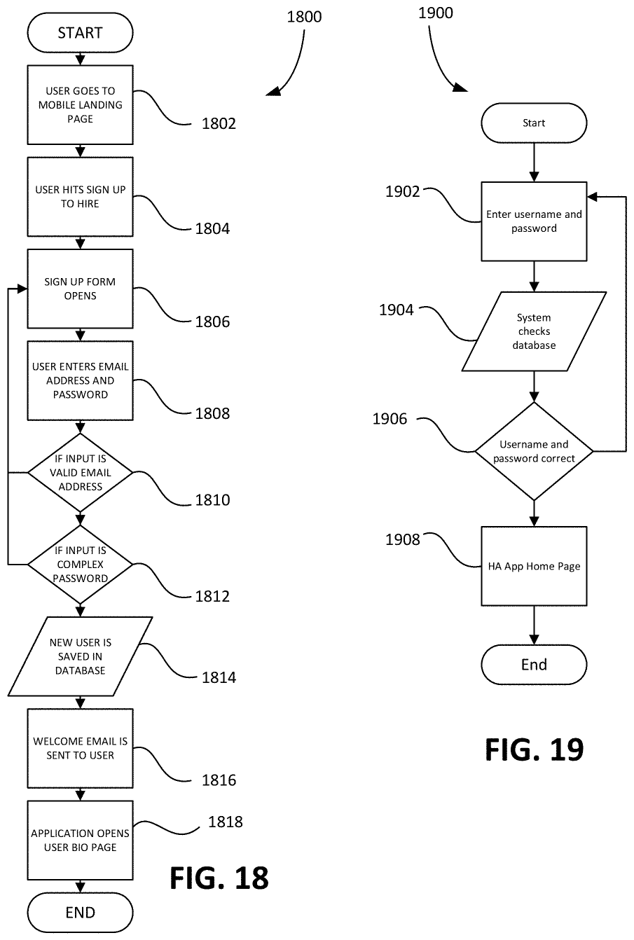

Referring now to FIG. 18, an embodiment of a method for users 106 of hiring authority 104 and/or hiring authority 104 to sign up for recruiting system 100 is illustrated and generally designated 1800. In step 1802, users 106 downloads the application of recruiting system 100 similarly to the process above for candidates. This step may include navigating to a landing page of recruiting system 100. In step 1804, users 106 signs up for hiring a new candidate. In step 1806, recruiting system 100 may display a sign-up form to users' 106 computing devices 112. In step 1808, users 106 may enter their email address and password for logging into recruiting system 100.

In step 1810, an inquiry is performed to determine whether recruiting system 100 recognizes or determines that users 106 email address is valid. If the answer to this inquiry is “yes,” then the method may proceed to step 1812. If the answer to this inquiry is “no,” then the method may proceed back to step 1806. In step 1812, an inquiry is performed to determine whether recruiting system 100 recognizes or determines that users 106 password sufficiently complex for security purposes to proceed. If the answer to this inquiry is “yes,” then the method may proceed to step 1814. If the answer to this inquiry is “no,” then the method may proceed back to step 1806. In step 1814, the users 106 are signed up and saved in the database(s) of recruiting system 100. In step 1816, a welcome email may be sent by recruiting system 100 to users 106 notifying them of the successful sign-up for the services and functionality of recruiting system 100. In step 1818, recruiting system 100 opens the biographical page of users 106 for completing.

Referring now to FIG. 19, an embodiment of a sign-in process for users 106 and/or hiring authority 104 to recruiting system 100 is illustrated and generally designated 1900. In step 1902, users 106 and/or hiring authority 104 enters their username, email address, password, etc. to login to recruiting system 100. In step 1904, recruiting system 100 verifies information with databases. In step 1906, an inquiry is performed to determine whether recruiting system 100 recognizes login information of users 106 and/or hiring authority 104. If the answer to this inquiry is “yes,” then the method may proceed to step 1908. If the answer to this inquiry is “no,” then the method may proceed back to step 1902. In step 1908, recruiting system 100 displays hiring authority's home page on computing devices 112.

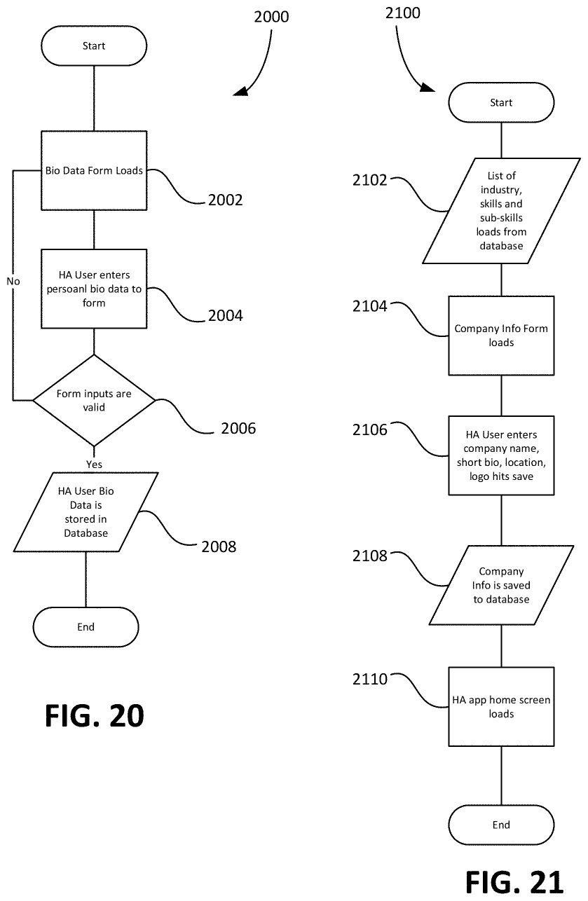

Referring now to FIG. 20, an embodiment of a biographical input process for users 106 and/or hiring authority 104 to recruiting system 100 is illustrated and generally designated 2000. In step 2002, recruiting system 100 loads a user biographical form or screen to users 106 and/or hiring authority 104 computing devices 112. In step 2004, users 106 and/or hiring authority 104 inputs or enters their biographical data and information into the screens or displays presented by recruiting system 100 as described herein. In step 2004, users 106 and/or hiring authority 104 inputs or enters their personal information or data as described herein. In step 2006, an inquiry is performed to determine whether recruiting system 100 recognizes this information or data of users 106 and/or hiring authority 104 as valid. If the answer to this inquiry is “yes,” then the method may proceed to step 2008. If the answer to this inquiry is “no,” then the method may proceed back to step 2002. In step 2008, recruiting system 100 stores the entered information or data of users 106 and/or hiring authority 104 to a database of recruiting system 100.

With reference to FIG. 21, an embodiment of a method for selecting skill information for candidate 102 to recruiting system 100 and is illustrated and generally designated 2100. In step 2102, a list of industry skills and sub-skills is loaded into the application from a database of recruiting system 100. In step 2104, this information may be then loaded into a form or screen as described herein. This step may include users 106 and/or hiring authority 104 selecting those skills and sub-skills of the position from the display or screen of computing devices 112, for example. In step 2104, recruiting system 100 displays a company information screen to users 106 and/or hiring authority 104 as described herein. In step 2106, users 106 and/or hiring authority 104 enters company name, short biographical information, location, logos, trademarks, and then saves this information to recruiting system 100 in step 2108. In step 2110, recruiting system 100 loads the home screen of users 106 and/or hiring authority 104.

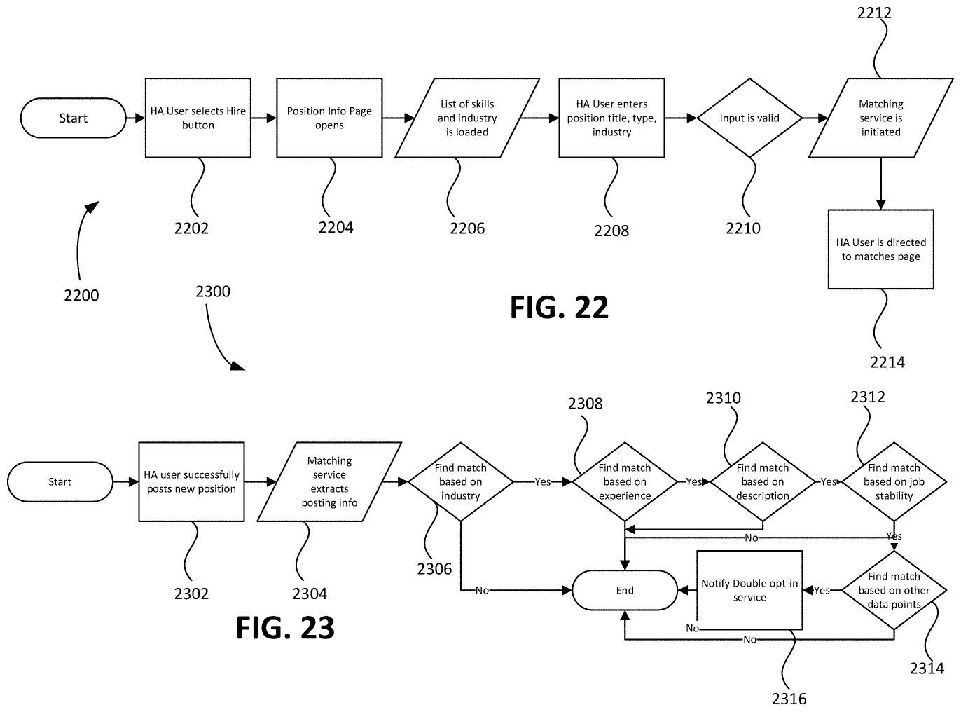

With reference to FIG. 22, an embodiment of a method for users 106 and/or hiring authority 104 to post a position in recruiting system 100 is illustrated and generally designated 2100. In step 2202, users 106 and/or hiring authority 104 selects a posting or hiring functions of recruiting system 100 as described herein. In step 2204, recruiting system 100 displays a position information screen to computing devices 112 of users 106 and/or hiring authority 104 as described herein. In step 2206, recruiting system 100 loads and skills and industry information for viewing by users 106 and/or hiring authority 104. In step 2208, users 106 and/or hiring authority 104 enters the position, title, type of industry, etc. into recruiting system 100. In step 2210, recruiting system 100 checks to ensure that the entered data is valid. If it is not, then recruiting system 100 may return to one of the previous steps. In step 2212, recruiting system 100 initiates the matching service of recruiting system 100. In step 2214, recruiting system 100 loads and directs users 106 and/or hiring authority 104 to a matches screen or page as herein described.

Referring now to FIG. 23, an embodiment of a process for initiating a match for a posted position is illustrated and generally designated 2300. In step 2302, users 106 and/or hiring authority 104 successfully posts a position as described above. In step 2304, the matching functionality of recruiting system 100 extracts posting information, such as from a database as described herein. In step 2306, an inquiry is performed to determine whether a user, such as users 106 and/or hiring authority 104, desires to find a match of candidate 102 based on industry. If the answer to this inquiry is “yes,” then the method may proceed to step 2308. If the answer to this inquiry is “no,” then the method may proceed to end.

In step 2308, an inquiry is performed to determine whether a user, such as users 106 and/or hiring authority 104, desires to find a match of candidate 102 based on experience. If the answer to this inquiry is “yes,” then the method may proceed to step 2310. If the answer to this inquiry is “no,” then the method may proceed to end. In step 2310, an inquiry is performed to determine whether a user, such as users 106 and/or hiring authority 104, desires to find a match of candidate 102 based on description. If the answer to this inquiry is “yes,” then the method may proceed to step 2312. If the answer to this inquiry is “no,” then the method may proceed to end.

In step 2312, an inquiry is performed to determine whether a user, such as users 106 and/or hiring authority 104, desires to find a match of candidate 102 based on stability. If the answer to this inquiry is “yes,” then the method may proceed to step 2314. If the answer to this inquiry is “no,” then the method may proceed to end. In step 2314, an inquiry is performed to determine whether a user, such as users 106 and/or hiring authority 104, desires to find a match of candidate 102 based on other data points. If the answer to this inquiry is “yes,” then the method may proceed to step 2316. If the answer to this inquiry is “no,” then the method may proceed to end. In step 2316, a double opt-in functionality activated in recruiting system 100.

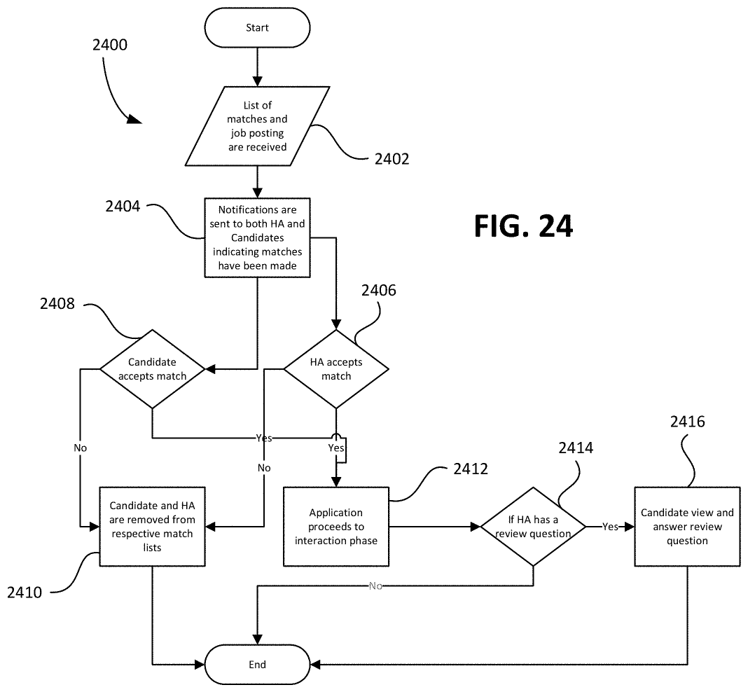

Referring now to FIG. 24, an embodiment of a process for matching candidate 102 to the position posted by hiring authority 104 is illustrated and generally designated 2400. In step 2402, recruiting system 100 matches those posted jobs with candidates having matching data. In step 2406, recruiting system 100 sends notifications to candidate 102 and hiring authority 104 that matches have been made. In step 2406, an inquiry is performed to determine whether matched hiring authority 104 desires to proceed with an interaction with the matched candidate 102. If the answer to this inquiry is “yes,” then the method may proceed to step 2412. If the answer to this inquiry is “no,” then the method may proceed to step 2410. In step 2408, an inquiry is performed to determine whether matched candidate 102 desires to proceed with an interaction with the matched hiring authority 104. If the answer to this inquiry is “yes,” then the method may proceed to step 2412. If the answer to this inquiry is “no,” then the method may proceed to step 2410.

In step 2412, candidate 102 and hiring authority 104 are removed from the respective match lists. In step 2412, recruiting system 100 directs and proceeds to the interaction phase between candidate 102 and hiring authority 104 as described herein. In step 2414, an inquiry is performed to determine whether has a review question. If the answer to this inquiry is “yes,” then the method may proceed to step 2416. If the answer to this inquiry is “no,” then the method may proceed to end. In steep 2416, candidate 102 may view and reply to the review question.

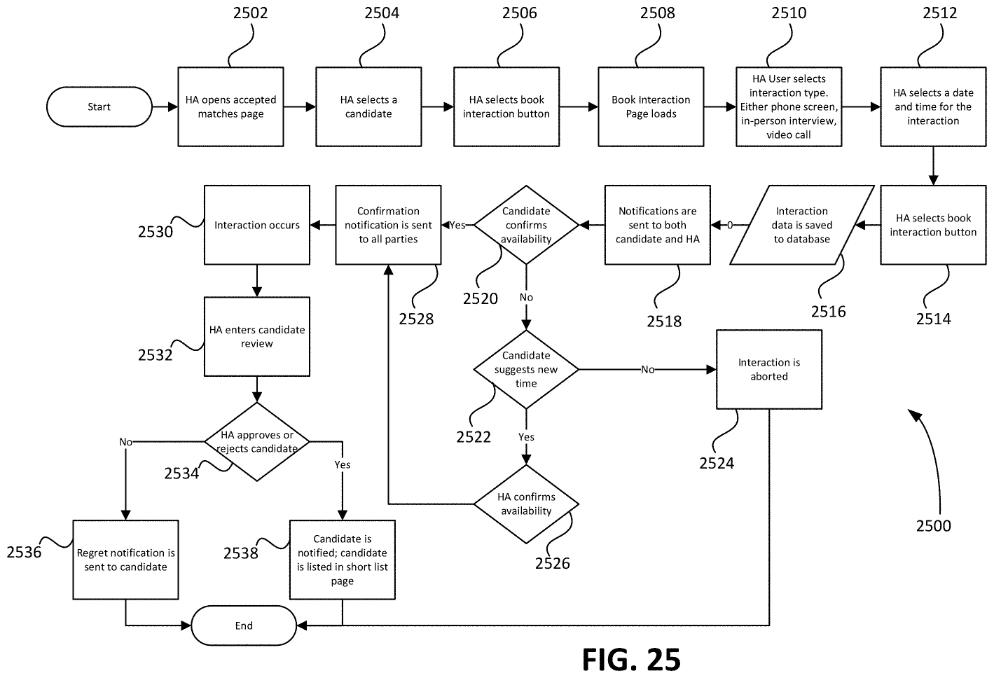

Turning now to FIG. 25, an embodiment of a process for facilitating and interaction between candidate 102 and 104 is illustrated and generally designated 2500. In step 2502, users 106 and/or hiring authority 104 opens or selects the accepted matches of candidate 102. In step 2504, users 106 and/or hiring authority 104 selects a candidate 102 that they wish to further an interaction as described herein. In step 2506, users 106 and/or hiring authority 104 selects the book interaction button on application as described herein. In step 2508, recruiting system 100 loads the book interaction screen as described herein. In step 2510, users 106 and/or hiring authority 104 selects interaction type as described herein. For example, some types may be phone interview, in-person interview, and/or video call.

In step 2512, users 106 and/or hiring authority 104 selects a date and time for the interaction. In step 2514, users 106 and/or hiring authority 104 books this in recruiting system 100 by selecting the interaction button as described herein. In step 2516, the interaction is saved to a database in recruiting system 100. In step 2518, recruiting system 100 sends notifications to candidate 102 and users 106 and/or hiring authority 104. In step 2520, an inquiry is performed to determine whether candidate 102 confirms the booking or availability to make book appointment. If the answer to this inquiry is “yes,” then the method may proceed to step 2528. If the answer to this inquiry is “no,” then the method may proceed to step 2522. In step 2522, an inquiry is performed to determine whether candidate 102 desires to suggest a new date/time. If the answer to this inquiry is “yes,” then the method may proceed to step 2526. If the answer to this inquiry is “no,” then the method may proceed to step 2524 where the process may be aborted. In step 2526, users 106 and/or hiring authority 104 confirms their availability to the newly suggested date/time. If users 106 and/or hiring authority 104 can confirm their availability, then the process proceeds to step 2528.

In step 2528, recruiting system 100 sends a confirmation notification to candidate 102 and users 106 and/or hiring authority 104. In step 2530, the interaction between candidate 102 and users 106 and/or hiring authority 104 occurs. In step 2532, users 106 and/or hiring authority 104 enters a review of candidate 102 as described herein. In step 2534, an inquiry is performed to determine whether users 106 and/or hiring authority 104 approves or rejects candidate 102. If the answer to this inquiry is “yes,” then the method may proceed to step 2538. If the answer to this inquiry is “no,” then the method may proceed to step 2536. In step 2538, candidate 102 is notified and candidate 102 is put on the short list as described herein. In step 2536, a regret notification may be sent to candidate 102.

While this invention has been described with reference to illustrative embodiments, this description is not intended to be construed in a limiting sense. Various modifications and combinations of the illustrative embodiments as well as other embodiments of the invention will be apparent to persons skilled in the art upon reference to the description. It is, therefore, intended that the appended claims encompass any such modifications or embodiments.

What is claimed is:

1. An interactive system for recruiting candidates, comprising:
at least one processor;
a memory connected to the at least one processor;
a module that when loaded into the at least one processor causes the at least one processor to:
accept the candidates' biographical data, skillset data, and educational data;
display lists of industry skills and industry sub-skills;
accept job postings by hiring authorities, the job postings having biographical data, required industry skills, and required industry sub-skills;
accept selections of the required industry skills and required industry sub-skills by hiring authorities relative to the job postings and candidates relative to their skillset data and educational data;
match the selected required industry skills and required sub-industry skills of the hiring authorities and candidates;
notify the hiring authorities and candidates of the match, wherein the candidates' biographical data is not sent to the hiring authorities in the notification; and
facilitate an interaction between matched candidates and hiring authorities.

2. The system of claim 1, wherein the module causes the at least one processor to:
display a geographical map to the hiring authorities having indicia of matched candidates within a defined geographical area; and
upon selecting a matched candidate, display the selected matched candidate's one or more biographical data, skillset data, and educational data to the hiring authorities.

3. The system of claim 1, wherein the module causes the at least one processor to:
display a geographical map to the candidates having indicia of matched hiring authorities within a defined geographical area; and
upon selecting a matched hiring authority, display the selected matched hiring authority's biographical data, industry skills, and industry sub-skills to the candidates.

4. The system of claim 1, wherein the module causes the at least one processor to:
record a video of candidates to be viewed by hiring authorities once the candidates and hiring authorities are matched.

5. The system of claim 1, wherein the module causes the at least one processor to:
display candidates' biographical data once the candidates and hiring authorities are matched.

6. The system of claim 1, wherein the module causes the at least one processor to:
accept payments from hiring authorities for posting jobs.

7. The system of claim 1, wherein the module causes the at least one processor to:
display to the hiring authorities a list of matched candidates and one or more selectable buttons for view biographical data and book interaction.

8. The system of claim 1, wherein the module causes the at least one processor to:
display to the hiring authorities a list of matched candidates and one or more selectable buttons for hire and reject.

9. The system of claim 7, wherein when the book interaction is selected the module causes the at least one processor to:
display to the hiring authorities one or more of a date field, interaction type field, a message field, and a book button.

10. The system of claim 9, wherein when the book interaction is selected the module causes the at least one processor to:
display to the hiring authorities one or more of a an interaction field, a hire button, and a final shortlist button.

11. An interactive method for recruiting candidates, comprising:
storing data from one or more candidates;
storing data from one or more hiring authorities;
accepting at least one job posting from the one or more hiring authorities, the at least one job posting having standard industry skills and standard industry sub-skills;
matching the at least one of the one or more candidates' data with the job posting standard industry skills and standard industry sub-skills;
notifying the matched one or more candidates and one or more hiring authorities that a match was made; and
facilitating an interaction between the matched one or more candidates and one or more hiring authorities.

12. The method of claim 11, wherein accepting at least one job posting further comprises:
accepting payment from the one or more hiring authorities for posting the at least one job posting.

13. The method of claim 11, wherein storing data from one or more candidates further comprises:
storing a video of the one or more candidates for viewing by the one or more hiring authorities.

14. The method of claim 11, wherein the matching further comprises:
providing a choice to the one or more candidates to accept or reject the at least one job posting, wherein the one or more candidates accepts the at least one job posting; and
providing a choice to the one or more hiring authorities to accept or reject the accepted candidate.

15. The method of claim 11, wherein the matching further comprises:
providing a choice to the one or more candidates to accept or reject the at least one job posting, wherein the one or more candidates accepts the at least one job posting; and
providing a choice to the one or more hiring authorities to accept or reject the accepted candidate.

16. The method of claim 11, wherein the matching further comprises:
displaying a geographical map to the hiring authorities having indicia of matched candidates within a defined geographical area; and
upon selecting a matched candidate, displaying the selected matched candidate's one or more biographical data, skillset data, and educational data.

17. The method of claim 11, wherein the matching further comprises:
displaying a geographical map to the candidates having indicia of matched hiring authorities within a defined geographical area; and
upon selecting a hiring authority, displaying the selected matched hiring authorities one or more biographical data, industry skills, and industry sub-skills to the candidates.
